(19) United States
(12) Patent Application Publication
(10) Pub. No.: US 2026/0234357 A1
(43) Pub. Date: Aug. 13, 2026

(54) CRACKING PROCESS FOR MAKING THERMOPLASTIC FROM MUNICIPAL SOLID WASTE

(71) Applicant: H&E RECYCLE TECH LTD., Jerusalem (IL)

(72) Inventors: Amit AZULAY, Be'er Shiva (IL); Jonathan J. GUTFARB, Rehovot (IL); Yaniv BEN-ZAKEN, Vered Yericho (IL); Asaph NEBENZAHL, Jerusalem (IL)

(21) Appl. No.: 19/131,141

(22) PCT Filed: Nov. 20, 2023
(86) PCT No.: PCT/IB2023/061704

§ 371 Date: May 19, 2025

Related U.S. Application Data
(60) Provisional application No. 63/384,427, filed on Nov. 20, 2022.

(51) Int. Cl. C08J 11/12; B09B 3/32; B09B 3/40; B09B 3/70; B09B 101/25

(52) U.S. Cl. CPC C08J 11/12; B09B 3/32; B09B 3/40; B09B 3/70; B09B 2101/25

(57) ABSTRACT

A method of converting raw municipal solid waste (MSW) to a composite material with thermoplastic properties, involves heating the MSW having a liquid content to a first pressure level, the first pressure level being sufficient to enable a temperature of the MSW to exceed an atmospheric boiling temperature of the liquid content, and instantaneously reducing the first pressure level of the heated MSW to a second pressure level. The instantaneous reduction enables the liquid content to instantaneously boil, to instantaneously cause evaporation of substantially all the liquid content, and to transform the heated MSW into the composite material having thermoplastic properties.

### CROSS REFERENCE TO RELATED APPLICATIONS

This application claims the benefit of priority of U.S. Provisional Patent Application No. 63/384,427, filed on Nov. 20, 2022, which is incorporated herein by reference in its entirety.

### TECHNICAL FIELD

This disclosure relates to recycling of waste materials into usable composite materials, using incorporated plastic materials and aggregates from waste while minimizing or eliminating the need for pre-sorting.

### BACKGROUND

Recycling is the collection and reuse of materials that would otherwise be considered waste. Motivations for recycling stem from environmental considerations, as the practice not only curtails the consumption of energy and raw materials but also diminishes the imperative for waste disposal. Traditional recycling technologies that process heterogeneous waste materials (e.g. mixed waste usually from domestic households) into useful plastic rely on pre-sorting to separate the raw waste into plastic and non-plastic materials (e.g., organic material, paper, aluminum, etc.) and utilize raw materials of plastic origin only. Pre-sorting is typically involved in a recycling process. However, pre-sorting requires resources (e.g., machinery, space, and effort). Furthermore, the sorting process typically results in large losses of raw material (up to 40%) as the organic material is separated and disposed of. In other words, traditionally a significant portion of a waste stream is not recycled.

Attempts to recycle without pre-sorting have required a waste stream to be pre-dried. Drying requires time, energy, and typically, dedicated drying equipment.

Through the use of principles described herein, businesses, communities, and/or organizations involved in waste recycling may benefit from significant increases in production capacity, reduced need for sorting, reduced or eliminated need for pre-drying, decreased cost and/or a higher percentage of a waste stream recycled. These benefits may be realized by increasing the availability and utility of raw waste to increase of production capacity and decrease the cost of production by avoiding the sorting process. There is thus a desire for new and improved techniques for recycling waste into usable material.

### SUMMARY

Unlike traditional technologies, the technology described herein may utilize an entire waste stream, including organic materials, paper, plastic, glass, metals, textiles, e-waste, and/or hazardous materials, to produce a high-quality composite material. Disclosed embodiments include unique apparatuses and processes for creating a thermoplastic composite material from a municipal solid waste (MSW) stream. In other words, the technology described herein harnesses effective homogenization of MSW to yield a valuable recycled thermoplastic composite.

The technology described herein may avoid the need for sorting and minimizes loss of organic material, thereby increasing the yield of final valuable recycled waste product and decreasing the cost of recycling.

As no separation is required (nor is the associated machinery and space), the recycling processes described herein provide cost benefits over traditional technologies. Moreover, the MSW employed as a raw material contain materials of low value such as organic materials and paper (up to 40% by weight). By homogenizing these low value materials with plastic and other existing waste materials to create a thermoplastic composite material, the value of the end product is significantly increased.

The technology described herein may further avoid the need to dry waste in advance of a recycling process, reducing time, cost, and space.

Consistent with some embodiments, a method of converting raw municipal solid waste (MSW) to a composite material with thermoplastic properties is disclosed. The method includes heating the MSW having a liquid content to a first pressure level, the first pressure level being sufficient to enable a temperature of the MSW to exceed an atmospheric boiling temperature of the liquid content. Thereafter, the pressure is instantaneously reduced from the first pressure level of the heated MSW to a second pressure level to: enable the liquid content to instantaneously boil; instantaneously cause evaporation of substantially all the liquid content; and transform the heated MSW into the composite material having thermoplastic properties.

Consistent with some embodiments, a composite material having thermoplastic properties is also disclosed. The composite material is formed from a municipal solid waste (MSW) stream including papers, plastics, metals, glass, and organics, the composite material being made via a process of heating the MSW having a liquid content to a first pressure level sufficient to enable a temperature of the MSW to exceed an atmospheric boiling temperature of the liquid content. Thereafter, the pressure is instantaneously reduced from the first pressure level of the heated MSW to a second pressure level to: enable the liquid content to instantaneously boil; instantaneously cause evaporation of substantially all the liquid content; and transform the heated MSW into the composite material having thermoplastic properties.

Consistent with some embodiments, a method of turning garbage into thermoplastic is disclosed. The method includes feeding wet raw municipal solid waste into an extruder; compressing the wet raw municipal solid waste in the extruder to a pressure level above atmospheric pressure; heating the wet raw municipal solid waste in the extruder; and advancing the wet raw municipal waste to a nozzle of the extruder for explosive cracking upon nozzle ejection.

Consistent with some embodiments, an extruder nozzle adapted for causing municipal solid waste cracking is disclosed. The extruder nozzle may include an inlet end configured for connection to an extruder barrel, an outlet end configured for expelling fragments of cracked municipal waste, an auger-free compression zone proximate the inlet end, the auger-free compression zone having a first cross-sectional area, and a tapered zone between the auger-free compression zone and the outlet end. The tapered zone may progressively reduce in cross-sectional area from the compression zone to the outlet end, such that a second cross-sectional area at the outlet end is smaller than the first cross-sectional area, such that a second cross-sectional area smaller than a first cross-sectional area to thereby enable a pressure increase in the tapered zone for facilitating micro-explosions in the municipal solid waste upon exit from the outlet end.

The foregoing general description and the following detailed description are exemplary and explanatory only and are not restrictive of the claims.

### BRIEF DESCRIPTION OF THE DRAWINGS

FIG. 1 is a cross-sectional view of an exemplary system for making thermoplastic from municipal solid waste, consistent with some disclosed embodiments.

FIG. 2 is a cross-sectional view of another exemplary system for making thermoplastic from municipal solid waste, consistent with some disclosed embodiments.

FIG. 3 is a flow diagram of a process for making thermoplastic from municipal solid waste, consistent with some disclosed embodiments.

FIG. 4 is a flowchart of an exemplary process for making thermoplastic from municipal solid waste, consistent with some disclosed embodiments.

FIG. 5 is a cross-sectional view of another exemplary system for making thermoplastic from municipal solid waste, illustrating various process zones and elements, consistent with some disclosed embodiments.

FIG. 6 is a flowchart of another exemplary process for making thermoplastic from municipal solid waste, consistent with some disclosed embodiments.

FIG. 7A is a cross-sectional view of a nozzle of an exemplary system for making thermoplastic from municipal solid waste, consistent with some disclosed embodiments.

FIG. 7B is an annotated cross-sectional view of a portion of another exemplary system for making thermoplastic from municipal solid waste, consistent with some disclosed embodiments.

FIG. 7C is a shockwave diagram of an exemplary phenomenon associated with some disclosed embodiments.

FIG. 7D is a cross-sectional view of an exemplary nozzle of a system for making thermoplastic from municipal solid waste, consistent with some disclosed embodiments.

FIG. 7E is a cross-sectional view of another exemplary system for making thermoplastic from municipal solid waste, consistent with some disclosed embodiments.

### DETAILED DESCRIPTION

Disclosed herein are systems, apparatuses, processes, and product by processes relating to the transformation of heterogeneous waste, or garbage, into thermoplastic. According to some embodiments, heterogenous waste includes a plurality of component types. The types of components may include components such as plastics, organics, paper, glass, metals, textiles, e-waste, and/or hazardous materials. Often some or all such components are present in MSW. Wet heterogenous waste is heated in a closed chamber under high pressure (e.g., in a plastic extruder) and then expelled to the atmosphere through a specially configured nozzle to instantaneously reduce the pressure. At the instant of pressure reduction, liquid in the waste changes phase into a gas through a series of micro-explosions. The micro-explosions facilitate transformation of the waste into a composite thermoplastic material.

The transformation occurs as the result of explosions of water molecules, water droplets, or clusters of water molecules distributed within each portion of the waste material. As these superheated molecules, droplets or clusters are exposed to atmospheric pressure, micro-explosions occur. The micro-explosions shear the associated waste material, severing intermolecular bonds, and causing formation of a new composite material. The new composite material may be characterized by a composition of fine particles differing from the original composition of the heterogeneous waste. In some embodiments, it is believed that the explosions further cause the formation of micro-bubbles, facilitating cooling and resulting in uneven, porous pellets (e.g. pop-corn like pellets). Exemplary uses for the homogenized materials include, but are not limited, to plastic extrusion, plastic injection, and plastic casting.

In some embodiments, the MSW may be ground or shredded prior to injection into a closed pressure chamber, such as an extruder. In other embodiments, no size reduction is required. In yet other embodiments, MSW is shredded to a predetermined maximum size to better facilitate the process (e.g., a size correlated to a size of an output nozzle, such as equal to or less than a size of the nozzle). According to some embodiments, the recycling processes and apparatus for converting heterogeneous waste to a thermoplastic composite material require minimal grinding but no pre-sorting of the heterogenous waste. That is, the recycling processes and apparatus are operative to process “as is” waste. Optionally, the waste can be presorted.

Some disclosed embodiments involve conversion of raw municipal solid waste (MSW) to a composite material with thermoplastic properties. Conversion refers to changing from one form to another. For instance, conversion may involve the transformation, alteration, adaptation, deformation, destruction, reconstruction, modification, reorganization, homogenization, adjustment, refashioning, revision, distortion, and/or variation of at least one chemical or physical property of a material to yield another material, differing from the initial material by the at least one chemical or physical property.

Raw refers to an unprocessed state of a material. For instance, raw may refer to a material state in which it exists, for example, in an unprocessed MSW stream. Raw may also refer to material which is pre-prepared for later processing. Thus, other examples of raw material include waste that is dried, wetted, separated, sorted, purified, shredded, ground, or treated in a way where the molecular structure of the waste components is not materially modified. Municipal solid waste (MSW) refers to the trash, garbage, refuse, or disposed matter of an individual, institution, municipality, or other community. Thus, the waste may be obtained from consumers, households, neighborhoods, communities, towns, cities, municipalities, companies, organizations, commercial or retail entities, and/or industrial entities. The trash, garbage, or disposed matter may include liquids together with solids. and the solids may include paper, cardboard, textile, plastic, rubber, foam, metal, glass, packaging, dirt, rock, wood, ceramic, organic, inorganic, biodegradable, compostable, food and/or plant matter, and any other types of materials that may be disposed by an individual, company, or institution and which are suitable for the processing techniques disclosed herein. In some embodiments, raw MSW may be pre-processed to have certain properties. For example, MSW may be pre-processed to have a minimum plastic content (such as a minimum of about 6% plastic). As another example, MSW may be pre-processed to have an initial moisture content of about 0-60%.

In some disclosed embodiments, raw MSW includes a plastic content and a non-plastic content. Plastic refers to polymeric materials. Non-limiting examples of polymers include polyolefins such as polyethylene and polypropylene, polyesters such as polyethylene terephthalate, aromatic polymers such as polystyrene, halogenated polymers such as polyvinyl chloride and polytetrafluoroethylene, nitrogen-containing polymers such as polyamide and polyurethane, and other natural or synthetic macromolecules composed of repeating subunits. Plastic content refers to a presence of plastic material within a substance or mixture. Plastic content measurement may be defined in terms of percentage, volume, and/or weight, depending on the material and the specific requirements of the analysis. Non-plastic content refers to a presence of non-plastic material within a substance or mixture. A non-plastic content measurement may be defined in terms of percentage, volume, and/or weight, depending on the material and the specific requirements of the analysis. In some disclosed embodiments, non-plastic content includes at least one persistent material. Persistent refers to existing or enduring over a period. Thus, a persistent material refers to matter which continues to exist over a period. For instance, a persistent material may continue to exist despite a period of interference. Examples of interference include heating, expanding, exploding, compressing, crushing, cutting, shredding, shearing, grinding, and any process having destructive impact. Examples of persistent material include metal, glass, thermoset polymer, rock, and any material having chemical and/or physical resistance to destruction. A persistent material may be changed in size by crushing or shredding, yet even in its reduced size, it may continue to exist in its original form.

Composite material refers to a material made of at least two parts or elements. Each of the at least two parts or elements may have different physical and/or chemical properties. For instance, each of the at least two parts or elements may be a different constituent component of MSW as described and exemplified elsewhere herein. Thermoplastic properties refer to a property of a material that is affected by heat. Thermoplastic properties may refer to characteristics of a material that softens and/or melts as a result of heating the material and rehardens and/or solidifies as a result of subsequent cooling. In some instances, a material having thermoplastic properties may be able to undergo this melting/solidifying cycle more than once. In some embodiments, a composite material with thermoplastic properties may be a material made of at least two different constituent components of MSW which may be reversibly softened and/or melted by heating and hardened and/or solidified by cooling.

In some disclosed embodiments, the thermoplastic properties of the composite material enable the composite material to be plastically formed into products. Plastic formation refers to the shaping and/or molding of a material. Examples of plastic formation include injection molding, blow molding, compression molding, rotational molding, casting, foaming, extrusion, thermoforming, and any process providing desired shaping and/or molding of a material. Products refers to manufactured articles. Many consumer products such electronics housings, packaging, toys, sports equipment, aesthetic liners and housings, and much more are made of plastic and are therefore categorized as products plastically formed. Additional examples of products plastically formed include, construction materials, industrial components, textiles, household goods, consumer goods, and any other article manufactured or refined for sale or use. Plastically formed into products therefore refers to shaping and/or molding to yield a manufactured article. As a non-limiting example, plastically formed into products may include extrusion into boards, such as decking boards.

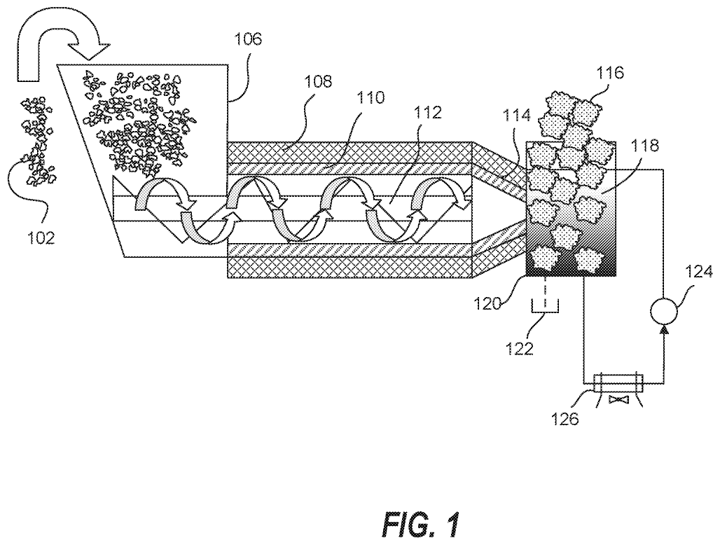

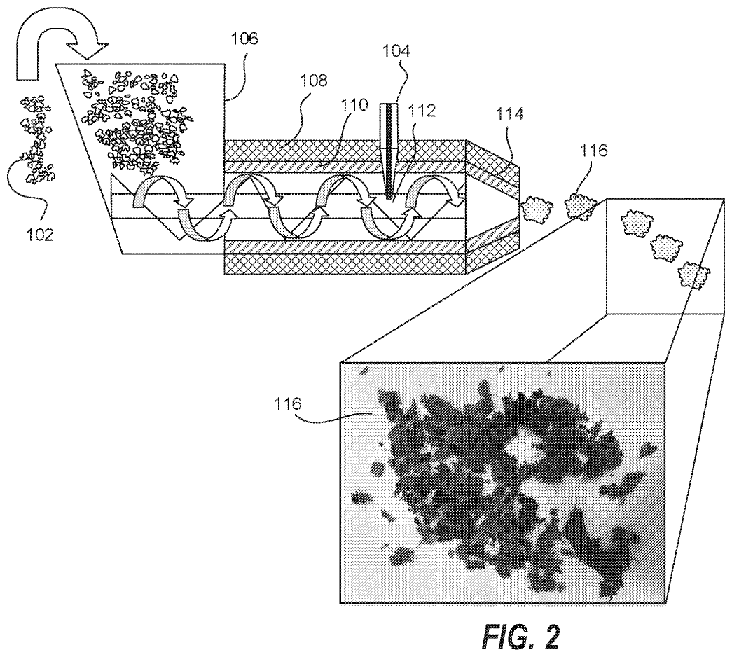

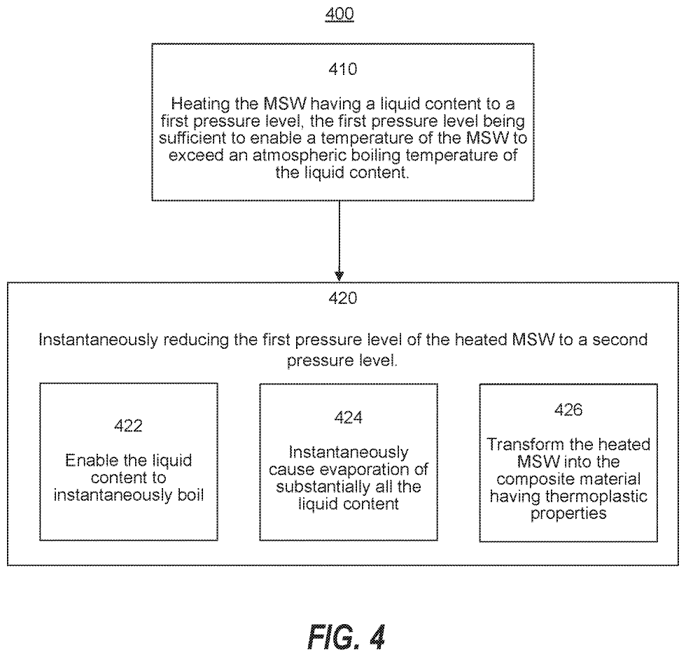

By way of a non-limiting example, FIG. 1 and FIG. 2 each show an illustration of an exemplary system and processor for converting raw MSW 102 to a composite material 116 with thermoplastic properties. Similarly, FIG. 4 shows an exemplary method 400 for converting raw MSW to a composite material with thermoplastic properties.

Some disclosed embodiments may involve off-the-shelf common machinery (e.g., plastic extruders or plastic injectors for crushed heterogenous waste), that are modified and supplemented with machinery designed especially for performing the disclosed operations.

For example, in some embodiments, a plastic extrusion machine may be used but modified to seal its degassing (gas ventilation) holes or vents and may have a specialized nozzle attached to the outlet of the extruder.

Some disclosed embodiments involve heating the MSW having a liquid content to a first pressure level. Heating refers an application of thermal energy. The heating may be accomplished in any manner, with any system, or using any method. Thermal energy may be measured in Joules or calories. Heating may involve the transfer of thermal energy between systems due to a temperature difference therebetween. For instance, thermal energy may radiate outwards from a heat source to a cooler surrounding environment, causing an increase in temperature of the surrounding environment and a decrease in temperature inside the heat source. Examples of heat sources include liquid heat sources, oil heat sources, gas heat sources, steam heat sources, and electric heat sources. Heating MSW refers to an application of thermal energy to the MSW to increase the temperature of the MSW. In some embodiments, during heating, a temperature of the MSW is raised to a temperature that causes a portion of the MSW to melt. For instance, the heating may cause a substantial portion of the MSW to melt. Melting refers to a process of changing a substance from a solid state to a liquid state as a result of an increase in temperature. In some embodiments, during heating, a temperature of the MSW is raised to between about 100° C. and about 400° C.

Liquid refers to a state of matter with a definite volume but no fixed shape. Examples of liquid include water, alcohol, oil, aqueous solutions, organic solvents, consumer beverages, bodily fluids and/or sewage. A liquid content refers to an amount or proportion of liquid within a substance. A liquid content may denote a volume or quantity of liquid present within a solid or another liquid substance. A liquid content of a material may be determined through various methods such as gravimetric analysis, moisture meters, or through specific testing procedures designed for different types of materials. A liquid content measurement may be defined in terms of percentage, volume, and/or weight, depending on the material and the specific requirements of the analysis. For example, a liquid content measurement may be defined in terms of percent (%) by weight, which is calculated as the weight of the liquid within a substance divided by the weight of the entire substance. MSW having a liquid content refers to the trash, garbage, refuse, or disposed matter of an individual or institution as described and exemplified elsewhere herein, including therein an amount of liquid. In some disclosed embodiments, a liquid content may be at least about 6% by weight. In some disclosed embodiments, a liquid content may be between about 6% by weight of the raw MSW and about 80% by weight of the raw MSW. In some disclosed embodiments, a liquid content may be between about 20% by weight of the raw MSW and about 40% by weight of the raw MSW. In some disclosed embodiments, a liquid content may be between at least about 30% of the raw MSW by weight. A liquid content may include one or more of water, household waste liquids such as leftover beverages, expired liquids, and other discarded liquids from households; natural liquids such as rain, run-off, melted snow, and other liquids from the environment; food waste liquids such as liquids generated from food scraps and food waste in households and food service establishments; cleaning product residues including residual liquids from cleaning products, detergents, and other household chemicals; personal Care Products including liquids from the disposal of personal care products, such as shampoos, conditioners, and lotions; industrial and commercial waste liquids and waste generated by businesses and industries such as process liquids, cleaning solutions, and other industrial fluids; and/or medical waste liquids. In some cases, medical waste, which can include liquids from healthcare facilities, may be part of the waste stream. However, medical waste is often handled separately due to its potential health hazards.

In some disclosed embodiments, a liquid content is a combination of liquid present in the raw MSW and a supplemental volume of liquid added during the heating or before the heating. A combination refers to a union or merging of at least two parts or elements. In some embodiments, the at least two parts or elements are different materials. In other embodiments, the at least two parts or elements are the same material. Raw MSW refers to unprocessed trash, garbage, refuse, or disposed matter of an individual or institution as described and exemplified elsewhere herein. Liquid present in the raw MSW refers to fluid material occurring in an unprocessed stream of trash, garbage, refuse, or disposed matter of an individual or institution. Supplemental refers to something that is added to what is already available. For instance, a supplemental volume may refer to an amount or enhancement to a volume already present. Volume refers to an amount of matter. For instance, volume may refer to an amount of a liquid. Volume may be measured or defined in terms of amount of space occupied by matter and may have units of liters (L), cubic meters, or gallons. A supplemental volume of liquid refers to an amount of liquid provided in addition to liquid which already available. For example, supplemental volume of liquid may refer to an amount of liquid provided in addition to an amount of liquid already present in raw MSW. The supplemental volume may be water, run-off from the MSW, or any other fluid that may facilitate the process.

Adding refers to incorporating one material into another. For instance, adding can involve physically combining one substance into another. Examples of adding include mixing, blending, coating, injecting, infusing, embedding, reacting, bonding, or other processes which physically and/or chemically incorporate materials. Adding liquid during the heating or before the heating involves supplementing the liquid in the waste either before an application of thermal energy to the MSW or while thermal energy is applied to the MSW.

Pressure refers to an amount force exerted on or against something over a given area. Pressure level refers to a measurable pressure exerted on a material. Pressure level may be measured in atmosphere (atm), pascal (Pa), bar, torr, pounds per square inch (psi), or millimeters of mercury (mmHg).

Some disclosed embodiments involve heating MSW having a first liquid content to a first pressure level sufficient to enable a temperature of the MSW to exceed an atmospheric boiling temperature of the liquid content. Atmospheric pressure refers to a force exerted on or against on object over a given area by the air around the object (i.e. ambient pressure).

Examples of atmospheric pressure include 1 atm, 101,235 Pa, 14.696 psi, 760 mmHg, or other equivalent conversion. It is to be understood, that these are just examples, and atmospheric pressure may vary based on altitude, geographic locations, and other influences. Boiling refers to a phase transformation from liquid to vapor. Boiling of a liquid may begin when a liquid reaches a boiling temperature. A boiling temperature of a liquid is dependent on the chemical identity of the liquid and a pressure level of the liquid. A boiling temperature of a liquid may increase as a pressure level of the liquid increases. Atmospheric boiling temperature of a liquid content refers to a temperature at which a liquid of the liquid content turns to vapor when the liquid content is subject to atmospheric pressure. As a non-limiting example, if a liquid content is water, an atmospheric boiling temperature of the liquid content at 1 atm is 100° C. A temperature exceeding an atmospheric boiling temperature of a liquid content therefore refers to a temperature greater than a temperature at which a liquid of the liquid content turns to vapor when the liquid content is subject to atmospheric pressure. As a non-limiting example, if a liquid content is water, a temperature exceeding an atmospheric boiling temperature of the liquid content at 1 atm is greater than 100° C. The boiling temperature of a liquid can be increased by increasing pressure. Said another way, by increasing pressure above atmospheric pressure, the boiling point of liquids can be increased. The resulting liquid whose boiling temperature is increased may be referred to as a superheated liquid.

A pressure level sufficient to enable a temperature of MSW to exceed an atmospheric boiling temperature of the liquid content refers to a pressure high enough that a liquid content within MSW, having a temperature exceeding the temperature at which the liquid content would otherwise boil, remains in liquid form. In other words, a first pressure level sufficient to enable a temperature of the MSW to exceed an atmospheric boiling temperature of the liquid content may be a pressure level which enables superheating of the liquid content. In some embodiments, a first pressure level sufficient to enable a temperature of MSW to exceed an atmospheric boiling temperature of the liquid content is between about 1 MPa and 50 MPa. It is to be understood that each discrete pressure level between about 1 MPa and 50 MPa is included in this disclosure.

By way of a non-limiting example, FIG. 4 shows a method 400 including a step 410 wherein MSW having a first liquid content is heated to a first pressure level, the first pressure level being sufficient to enable a temperature of the MSW to exceed an atmospheric boiling temperature of the liquid content. FIG. 1 provides one non-limiting example of how this may be accomplished when a heterogenous mixture of raw MSW 102 having a first liquid content is fed via hopper 106 to an extruder chamber 110. Raw MSW 102 may be fed into hopper 106 from any direction by gravity or forced by any other means. Prior to introduction into the hopper, the raw MSW may be processed in a shredder, crusher, impactor, milling equipment, or other device for reducing size (not shown) to reduce the size of waste particles. In some embodiments, the reduced size may correspond to a size smaller than a size of the nozzle opening to minimize risk of clogging. In some embodiments, the reduced size may be about 8 mm to about 20 mm. In other embodiments, the forces and/or temperatures within the shredder may be sufficient to shred, melt, or otherwise sufficiently reduce the MSW particle size. After the MSW enters the extruder chamber 110, the waste is then driven by a revolving screw auger 112 into the extruder chamber 110. The extruder chamber 110 is heated by a heating element 108. In some embodiments, the heating means may include electric heating elements, gas burners, oil burners, or other devices or components capable of generating or transferring sufficient heat to extruder chamber 110. Heating element 108 may apply uniform heat or may have distinct zones so that differing temperatures may be applied to differing zones. The screw auger 112 may also contributes to the heating and pressurization of the MSW having a first liquid content to a first pressure level. Thus, the MSW may have a first liquid content heated to a desired temperature and pressure in a nozzle 114. For example, because the nozzle 114 has smaller diameter and thus a smaller cross section than the extruder chamber 110, the pressure of waste moving through the extruder chamber 110 will increase. The temperature of the raw MSW 102 having a first liquid content may increase to 100-400° C., which encompasses the melting point(s) of one or more types of plastic inside the MSW, and the first pressure level may increase to 1-50 MPa.

By way of another non-limiting example, FIG. 2 shows another exemplary system for making thermoplastic from municipal waste. As shown, a heterogenous mixture of raw waste 102 is fed into a hopper 106 and compressed in extruder chamber 110. The extruder chamber is heated by heating element 108 such as electric heating elements or by gas or oil burners as described above. The heated raw waste may then be compressed by a screw auger 112 and heated to a desired temperature and first pressure level. Liquid may also be added to extruder chamber 110 through an injection nozzle 104. An injection nozzle 104 may be a single nozzle, as illustrated, or may be a system of two or more nozzles. As illustrated, injection nozzle 104 is located in an upper portion of the wall of chamber 110. In an alternate embodiment, injection nozzle 104 may be located in a side portion of the wall of chamber 110.

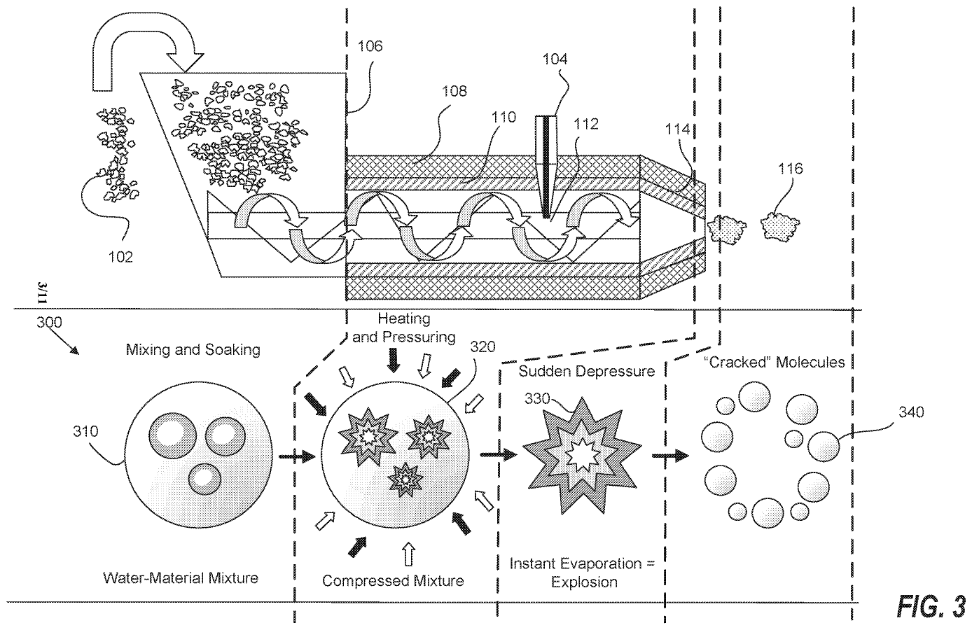

By way of another non-limiting example, FIG. 3 illustrates a method 300 by which raw MSW 102 having a first liquid content may form a water-material mixture 310 before and/or during introduction and/or conveyance through hopper 106. Mixture 310 is heated and pressurized to a first pressure level in extruder chamber 110 by heating element 108 and revolving screw auger 112 to form a melted and compressed mixture 320.

Some disclosed embodiments involve instantaneously reducing the first pressure level of heated MSW to a second pressure level. An instantaneous reduction refers to a pressure drop that occurs in an infinitesimally short moment or a specific point in time. It describes something that happens, exists, or is measured at a particular instant, with no duration or an extremely brief duration. For example, an instantaneous reduction may occur within a moment, a split-second, or a similar time frame not readily discernable by a naked eye.

Instantaneous reduction of a pressure level therefore refers to a decrease in pressure level occurring or completed without delay or perceptible duration of time. In some instances, instantaneous reduction of a pressure level of the heated MSW is achieved by conveying the heated MSW from a first environment exerting a first pressure level to a second environment exerting a second pressure level wherein the first and second environments are adjacent each other at an interface. For example, the instantaneous reduction of a pressure level of the heated MSW may occur at a moment the heated MSW is conveyed across the interface between the first and second environments having a first and second pressure level, respectively. In some disclosed embodiments, a second pressure level is an atmospheric pressure.

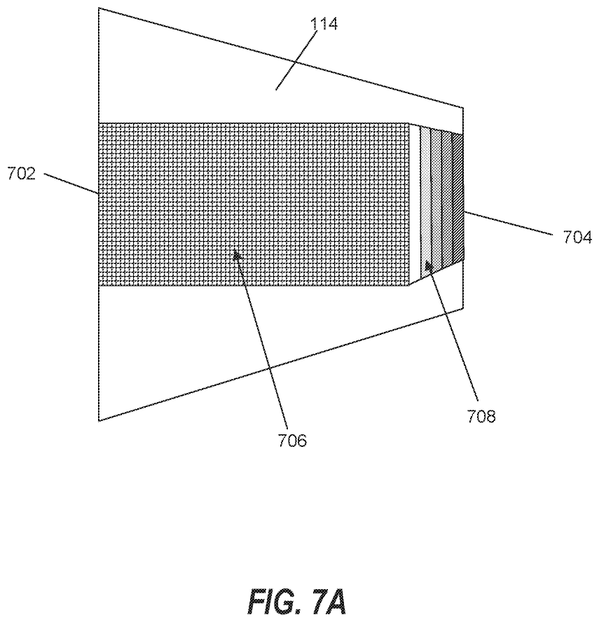

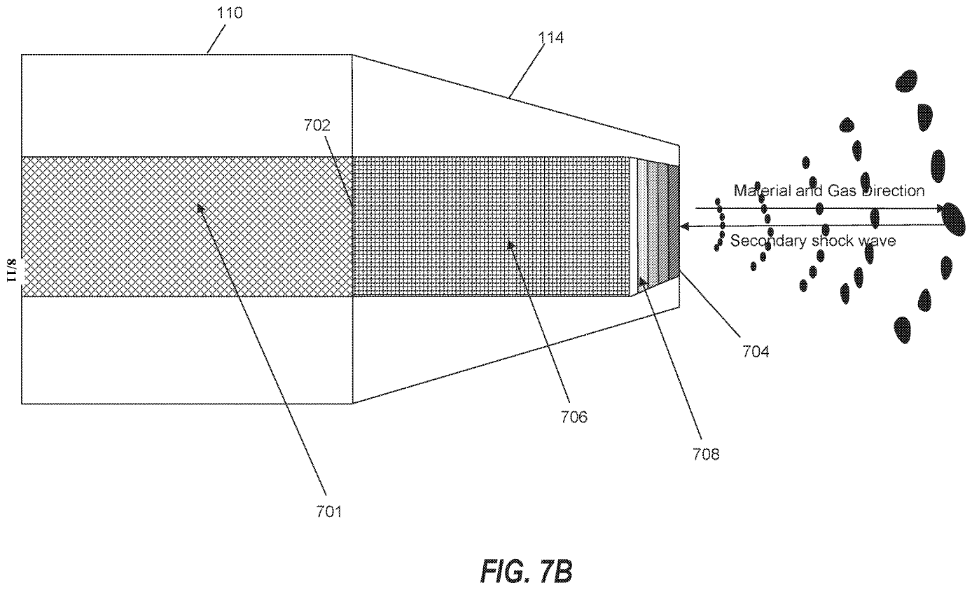

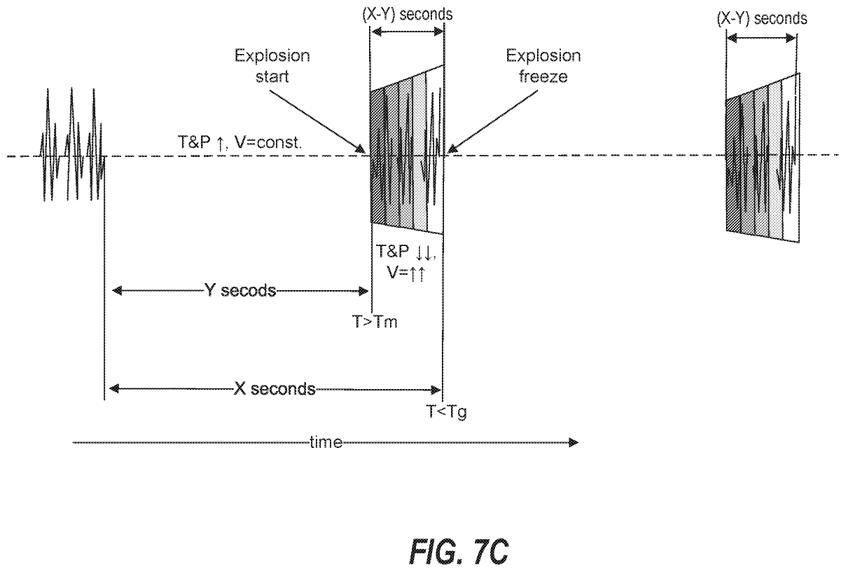

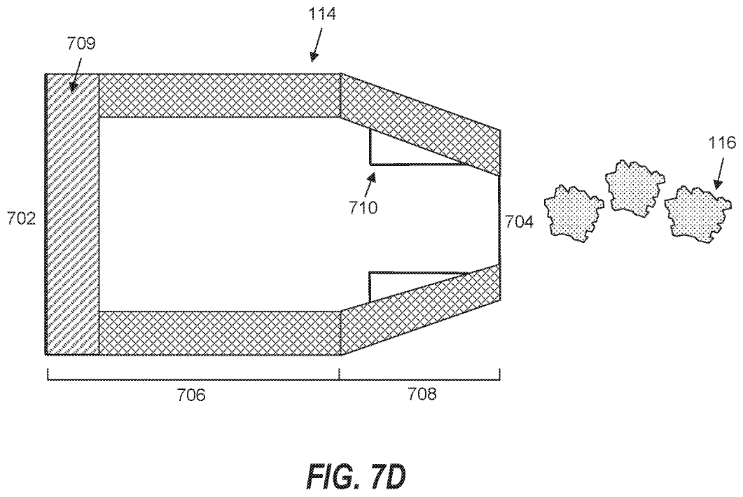

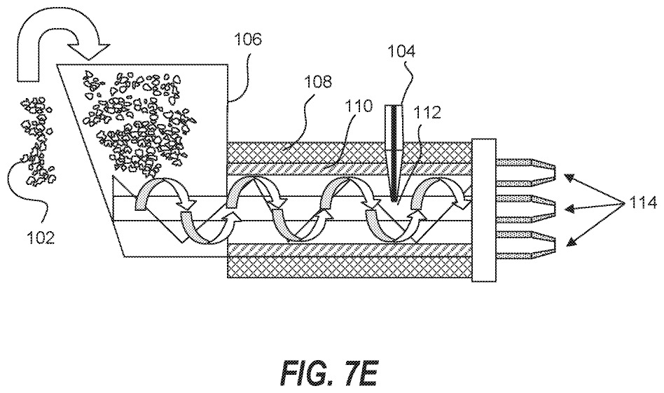

By way of non-limiting example, as illustrated in FIG. 7B, the pressure in nozzle 114 may be maintained at the first pressure level until it reaches the nozzle exit 704, at which time the pressure drops instantaneously to atmospheric pressure. It should be noted that the first pressure level need not be a specific pressure that remains constant. Rather, the first pressure level may be a range of pressures that encompasses pressures above which liquid in the MSW boils. Thus, when the MSW reaches the farthest location in the nozzle adjacent nozzle exit 704, an instantaneous pressure drop occurs as the superheated liquid in the MSW is exposed to atmospheric pressure, leading to explosions that occur as the result of instantaneous boiling.

In some disclosed embodiments, a liquid content is substantially absorbed by heated MSW prior to instant pressure reduction. Absorbed refers to a substance which is taken in or soaked up by another substance. For instance, when a substance is absorbed into another substance, the absorbed substance permeates or penetrates into the other substance's structure or is assimilated into it. Substantially absorbed refers to a substance having a majority of its volume or mass which is taken in or soaked up by another substance. For example, a substantially absorbed substance may include at least 20% of its volume or mass which is permeated or penetrated into the other substance. For example, a substantially absorbed substance may include at least 50% of its volume or mass which is permeated or penetrated into the other substance. For example, a substantially absorbed substance may include at least 75% of its volume or mass which is permeated or penetrated into the other substance. In other examples, a substantially absorbed substance may include at least 90% of its volume or mass which is permeated or penetrated into the other substance. In other examples, a substantially absorbed substance may include at least 95% of its volume or mass which is permeated or penetrated into the other substance. In other examples, a substantially absorbed substance may include at least 99% of its volume or mass which is permeated or penetrated into the other substance. Therefore, a liquid content which is substantially absorbed by heated MSW refers to an amount or proportion of liquid wherein a majority of that amount or proportion of liquid is taken in or soaked up by the heated MSW. The proportion that may be absorbed includes each distinct percentage between about 20% and 100%.

In some disclosed embodiments, instantaneous pressure reduction causes at least some of persistent material be capsulized and embedded in the composite material. Persistent material refers to matter which continues to exist over a period as described and exemplified elsewhere herein. Composite material refers to a material made of at least two parts or elements as described and exemplified elsewhere herein. Capsulized refers to something that is enclosed or encapsulated. Material that is capsulized is enclosed within a capsule or similar structure. In some embodiments, capsulized material is confined or contained within another material. In some embodiments, the capsulized material is enclosed within an outer layer of similar or the same material. Capsulized material may have a generally small volume, space, or format. Embedded refers to a material which is fixed, attached, or integrated with another material. In some embodiments, an embedded material is fixed, attached, or integrated firmly and/or deeply within another material. Therefore, persistent material capsulized and embedded in composite material refers to a material which continues to exist after the instantaneous pressure reduction and is confined or contained within and fixed, attached or integrated with the composite material formed from the instantaneous pressure reduction. In some embodiments, the presence of persistent capsulized material may be discernable as particles embedded within and showing through the composite. For example, speckles or shreds of metal may be visible in the resulting composite, and may be a telltale sign of persistent capsulized material. Thus, capsulated does not necessarily require that persistent material is completely covered by surrounding composite. In other examples, pieces of composite may be completely surrounded and may be revealed by severing pieces of composite.

In some embodiments, melted MSW may be forced through a nozzle. The melted MSW may contain water that does not evaporate due to a high pressure of the material. Upon the melted MSW exiting the nozzle into a cooling chamber, or alternatively directly into the atmosphere, an instant pressure reduction will occur around the melted MSW causing the water to boil and evaporate through explosion, thereby forming a capsulized portion of composite material.

By way of a non-limiting example, FIG. 4 shows a method 400 including a step 420 wherein a first pressure level of the heated MSW is instantaneously reduced to a second pressure level. For example, as illustrated in FIG. 1, after raw MSW 102 is heated and compressed to a first pressure level, it is released into a cooling chamber 120 containing liquid 118 (such as water). For example, melted MSW may be forced out of extruder chamber 110 through a nozzle 114 by a revolving screw auger 112 into a cooling chamber 120, resulting in a reduction of the first pressure level to a second pressure level, thereby creating homogenous porous pellets of thermoplastic composite material 116. The water temperature may be controlled by a heat exchanger 126 and circulated in a closed-loop by pump 124.

By way of another example, as illustrated in FIG. 2, the heated and compressed waste may be released directly to the atmosphere. As illustrated in FIG. 2, as molten MSW exits nozzle 114, the pressure instantly drops to a second pressure level, which is at atmospheric pressure, causing liquid which is present in MSW to explode. This explosion not only shears the material, but may also shear the intermolecular bonds, to form porous homogenous pellets of thermoplastic composite material 116. Similarly, FIG. 3 illustrates a method 300 wherein melted and compressed MSW 320 in an extruder chamber 110 is forced through a nozzle 114 to cause sudden depressurization and instant evaporation or explosion 330. This explosion results in thermoplastic composite material 116 which includes cracked molecules 340.

Some disclosed embodiments involve enabling a liquid content to instantaneously boil. Instantaneous refers to occurring or completing without delay or any perceptible duration of time as described and exemplified elsewhere herein. Boiling refers to a phase transformation from liquid to vapor as described and exemplified elsewhere herein. Enabling refers to making possible or practicable. For example, an occurrence may be enabled by conditions at which the occurrence is possible, likely, or certain to transpire. Enabling a liquid content to instantaneously boil therefore refers to making possible or practicable for a liquid content to turn to a vapor without delay or any perceptible duration of time. For instance, advancing the superheated MSW through the extruder chamber 110 to nozzle 114, enables instantaneous boiling as the result of an instantaneous reduction of a first pressure level of the heated MSW to a second pressure level as described and exemplified elsewhere herein.

Some disclosed embodiments involve instantaneously causing evaporation of substantially all a liquid content. Causing refers to bringing about an effect or a result. Examples of causes include those direct, indirect, contributing, necessary, or sufficient for bringing about an effect or a result. The effect or result may be intended or unintended. Evaporation refers to the transformation of a liquid to a gas. Evaporation may occur via boiling as described and exemplified elsewhere herein. Thus, the movement of the MSW containing liquid through extruder chamber 110 to the nozzle exit causes evaporation when the liquid boils. Substantially all a liquid content refers to at least about 75% of the liquid content in the MSW. In some embodiments, substantially all the liquid refers to at least about 85% of the liquid content in the MSW. In some embodiments, substantially all the liquid refers to at least about 90% of the liquid content in the MSW. In some embodiments, substantially all the liquid refers to at least about 95% of the liquid content in the MSW. In some embodiments, substantially all the liquid refers to at least about 97% of the liquid content in the MSW. In some embodiments, substantially all the liquid refers to at least about 99% of the liquid content in the MSW. In some embodiments, the instantaneous evaporation of substantially all the liquid content may be caused by a reduction of a first pressure level of the heated MSW to a second pressure level as described and exemplified elsewhere herein.

Some disclosed embodiments involve instantaneous boiling and instantaneous evaporation manifest in an explosion. Manifest refers to something being expressed, revealed, or displayed. Thus, the instantaneous boiling and evaporation may be expressed, revealed, or displayed in the form of an explosion. An explosion refers to a sudden release of energy which may be violent and which may have a magnitude proportionate to the amount of energy released. An explosion may be accompanied by a rapid outward expansion of gases and may cause noise, heat, light, and/or the formation of a shockwave. In some embodiments, an explosion occurs within heated MSW. In some embodiments, an explosion within heated MSW causes shear forces acting on the heated MSW. In some embodiments, the shear forces shred the contents of the heated MSW. In some embodiments, the shear forces break intermolecular bonds in the heated MSW.

Some disclosed embodiments involve causing a series of explosions in succession. A series refers to a set of related things which follow a particular order or pattern. In succession refers to one after the other. In some embodiments, explosions in succession may occur without interruption or may occur in intervals. The series may occur consecutively. The series of explosions may have a pattern along the lines of popcorn popping or a machine gun firing.

For example, in some embodiments, melted MSW including a liquid content at a high pressure may be forced through a nozzle to create an instant pressure reduction that instantly causes the liquid content to change its phase from liquid to gas through explosion. In some embodiments, the nozzle may be referred to as a die head. This explosion occurs simultaneously inside the melted MSW enforcing shearing effect inside the molten waste, crushing it effectively to a small piece. As each successive boundary layer of melted MSW containing superheated liquid is exposed to atmospheric pressure, each succeeding boundary layer may explode. Thus, as the extruder continues to advance MSW through the nozzle, the explosions occur in succession.

Some disclosed embodiments involve transformation of heated MSW into a composite material having thermoplastic properties. As described and exemplified elsewhere herein with respect to conversion, transformation refers to a change in at least one chemical or physical property of a material to yield another material, differing from the initial material by the at least one chemical or physical property. Composite material refers to a material made of at least two parts or elements as described and exemplified elsewhere herein. Likewise, a composite material with thermoplastic properties may be a material made of at least two different elements, such as two different constituent components of MSW, which may be repeatedly and reversibly softened and/or melted by heating and hardened and/or solidified by cooling as described and exemplified elsewhere herein. Transformation of heated MSW into a composite material having thermoplastic properties therefore refers to a changing of one form of material (heated MSW) to another (a composite material having thermoplastic properties). The composite material having thermoplastic properties differs from the initial heated MSW by at least one chemical or physical property.

By way of a non-limiting example, FIG. 4 shows a method 400 including a step 420 wherein a first pressure level of the heated MSW is instantaneously reduced to a second pressure level which enables: (1) a liquid content to instantaneously boil, 422; (2) instantaneous evaporation of substantially all the liquid content, 424; and (3) transformation of heated MSW into a composite material having thermoplastic properties, 426. For example, FIG. 2 illustrates a process by which heated MSW in an extrusion chamber 110 is forced through nozzle 114 to instantaneously reduce a first pressure level of the heated MSW to a second pressure level to transform the heated MSW into a composite material 116 having thermoplastic properties. Similarly, FIG. 3 illustrates a method 300 wherein melted and compressed MSW 320 in an extruder chamber 110 is forced through a nozzle 114 to cause sudden depressurization from a first pressure level to a second pressure level to enable a liquid content of the MSW to instantaneously boil, resulting in instantaneous evaporation 330 of substantially all the liquid content. This instantaneous boiling transforms the heated and compressed MSW into composite material 116 having thermoplastic properties.

Some disclosed embodiments involve a composite material having thermoplastic properties and being formed from a MSW stream including papers, plastics, metals, glass, and organics. Formed from refers to the creation, construction, or development of something from something else. In some embodiments, the creation, construction, or development results in a new material from pre-existing materials. In some embodiments, the pre-existing materials include MSW. Stream refers to a source of material. MSW stream therefore refers to a source of trash, garbage, refuse, or disposed matter of an individual or institution. In some embodiments, the MSW stream may be sourced directly from the individual or institution. In some embodiments, the MSW stream may be sourced from an intermediary who collects the trash, garbage, refuse, or disposed matter of an individual or institution or multiple individuals and/or institutions. In some embodiments, categories of waste in a MSW stream include, but are not limited to papers, plastics, metals, glass, and organics. Papers refer to materials made from cellulose fibers typically derived from wood pulp or other sources like cotton or recycled paper. Plastics refer to synthetic materials made from polymers, including thermoplastics that can be melted and remolded. Plastics may also include thermosetting plastics that undergo a chemical change during initial molding which makes them harden irreversibly. Metals refer to chemical elements such as iron, copper, aluminum, gold, silver, platinum, and other elements that exhibit one or more known characteristics of metals such as conductivity, malleability, ductility, and luster. Glass refers to a transparent or translucent material formed by cooling a molten material rapidly. Examples of glass include soda-lime glass used in windows and bottles, borosilicate glass used in heat-resistant cookware, tempered glass used in safety windows and doors, and fused silica glass used in optics and semiconductors. Organics refer to substances containing carbon that are typically derived from living organisms or their byproducts. Examples of organics include plants and plant products, animal products such as leather, wool, silk, or waste, microbial products such as microorganisms or organic acids, and fossil fuels such as oil, coal, or gas. While MSW may refer to the mishmash of garbage as it is received from a dumpster or garbage truck, in the broadest sense the term MSW refers to any mixture of garbage that includes multiple different categories of waste.

Some disclosed embodiments involve a composite material being made via a process comprising steps described and exemplified elsewhere herein such as heating MSW having a liquid content to a first pressure level, the first pressure level being sufficient to enable a temperature of the MSW to exceed an atmospheric boiling temperature of the liquid content, and instantaneously reducing the first pressure level of the heated MSW to a second pressure level to enable the liquid content to instantaneously boil; instantaneously cause evaporation of substantially all the liquid content; and transform the heated MSW into the composite material having thermoplastic properties.

In some disclosed embodiments, the composite material having thermoplastic properties has a fibrous and flaky structure. Fibrous refers to a quality of including stringy, thread-like, or filamentous texture or appearance. Fibrous materials may be characterized by structural elements having a roughly cylindrical shape with a length much greater than a cross-section. For example, fibrous materials may include long and thin structures. Examples of fibrous structures include manifestations that are visually thread-like, hairlike, or have an appearance like fiberglass, paper fiber, nylon filaments. Flaky refers to a quality of including thin, flat fragments. For instance, flaky materials may be characterized by small layers which protrude from a surface of a material. In some embodiments, the thin, flat fragments of a flakey material break or separate easily from the material. Flaky materials may have a rough and irregular surface area. In some embodiments, the composite material having thermoplastic properties has a fibrous and flaky structure when viewed with a human eye. Structure refers to an arrangement, organization, or characterization of matter within an object. Fibrous and flaky structure refers to an object arranged, organized, or characterized by matter having stringy, thread-like, or filamentous texture or appearance and thin, flat fragments of matter. FIG. 2 illustrates composite material that has both a flaky and fibrous structure. In some embodiments, the composite material having thermoplastic properties has a wool-like appearance when viewed with an electron microscope. In some embodiments, the composite material having thermoplastic properties is sterilized or neutralized relative to the raw MSW. Sterility refers to the state of being free from living microorganisms, including bacteria, viruses, fungi, and other potentially infectious agents. In a sterile environment or on a sterile surface, there are no viable microorganisms that could potentially cause contamination or infection. Neutralization refers to acidic or basic properties altered or counteracted to bring it to a neutral state (at or near a pH of 7.) In some disclosed embodiments, the composite material having thermoplastic properties is porous. Porous refers to a quality of material including voids within its structure. In some embodiments, the voids are irregular in size, shape, and/or location throughout the material. In some embodiments, the voids may be discrete. In some embodiments, voids may be connected, to thereby form tortuous paths throughout the material. In some embodiments, the voids may be holes, gaps, spaces, crevices, cavities, pits, cracks, fissures, or any other structure resulting in a discontinuous mass.

By way of non-limiting example, FIG. 4 shows an exemplary method 400 which for converting raw MSW to a composite material with thermoplastic properties. FIGS. 1 and 2 each show an illustration of an exemplary system and processor for converting raw MSW (garbage) 102 to a composite material 116 with thermoplastic properties. For example, FIG. 2 shows an expanded view of the composite material 116 with thermoplastic properties having a fibrous and flaky structure.

Some disclosed embodiments involve turning garbage into thermoplastic. Garbage refers to waste material. Examples of garbage include MSW as described and exemplified elsewhere herein. Thermoplastic refers to a material that is affected by heat as described and exemplified elsewhere herein. Turning is synonymous with conversion and refers to changing something from one form to another as described and exemplified elsewhere herein.

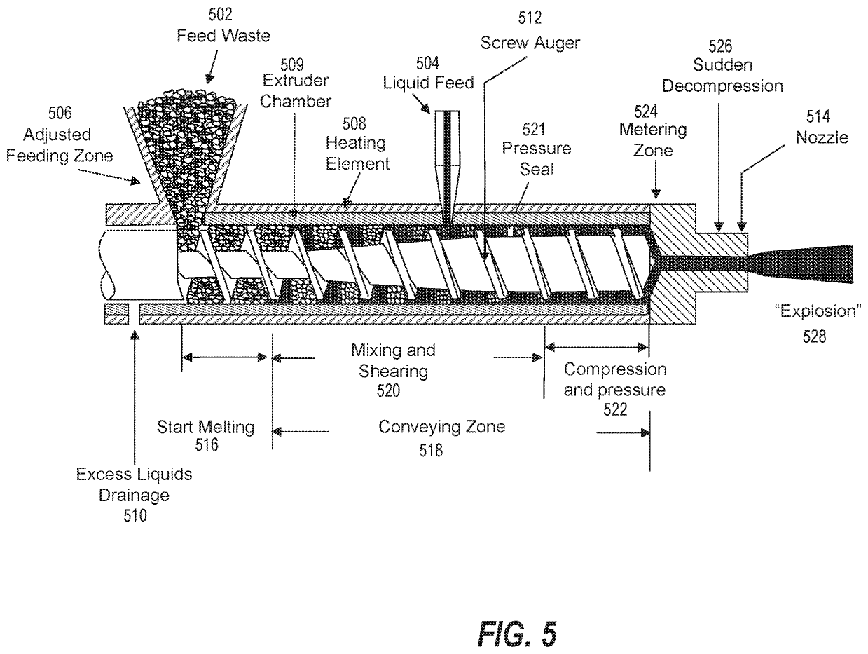

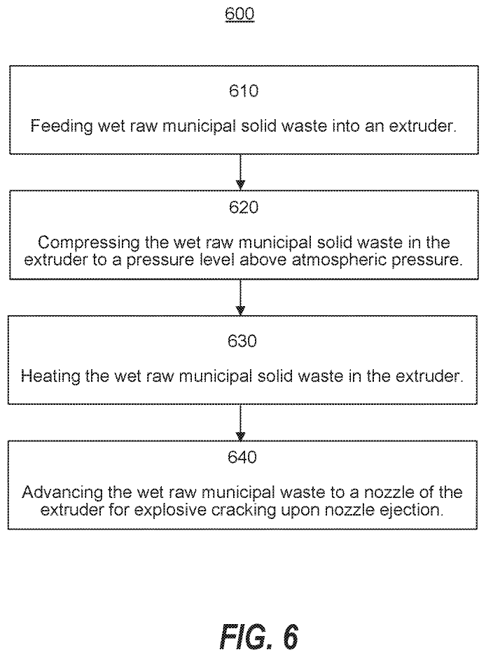

By way of a non-limiting example, FIG. 6 shows a method 600 of converting garbage into thermoplastic. For example, FIG. 1 and FIG. 2 illustrate an exemplary system and processor for converting raw MSW 102 (i.e. garbage) to a composite material 116 with thermoplastic properties (i.e. thermoplastic). As another example, FIG. 5 illustrates an exemplary system and processor for converting feed waste (garbage) 502 to a thermoplastic.

Some disclosed embodiments involve feeding wet raw municipal solid waste into an extruder. Raw municipal solid waste (MSW) refers to trash, garbage, refuse, or disposed matter as described elsewhere herein. The MSW may be shredded or size-reduced before introduction into the extruder, such as through the use of a shredder. Wet raw MSW refers to trash, garbage, refuse, or disposed matter as described elsewhere herein, having a liquid content. Feeding refers to supplying or introducing an input into a system or equipment. In some embodiments, feeding may involve supplying or introducing raw materials into a production line. In some embodiments, the feeding may involve introduction of the necessary elements to sustain or facilitate functioning of the production line or to produce a desired output. Feeding may be manual or mechanized, depending on the design needs of the system or equipment. Feeding may employ gravity, allowing an input to flow naturally under the influence of gravity from a higher elevation to a lower one, thereby feeding the input into the system or equipment below. Feeding may also employ mechanical energy to move an input from a position lower than the desired system or equipment to an inlet in that system or equipment. Equipment for feeding may include conveyor systems, hoppers or chutes, robotics, or any other means suitable for introduction of an input the desired system or equipment. Hoppers or chutes allow an input to be loaded into a temporary storage container, which gradually releases the input into the system or equipment.

An extruder refers to a machine for forcing a material through an orifice. An extruder may include one or more barrels and one or more openings for receiving raw material. The extruder may, for example, be of a single screw type or the twin screw type. Thus, the extruder may include at least one screw or auger which mixes, conveys, and compresses material in one or more barrels. The screw may be designed with a specific shape and configuration to suit the material being processed. The extruder may include a motor or drive system which powers the screw to rotate. In some embodiments, the motor may power the screw to rotate at a speed between about 50 rpm and about 500 rpm. In some embodiments, the motor may power the screw to rotate at a speed between about 80 and about 300 rpm. Speeds that may be employed within the scope of this disclosure include each distinct value between about 50 rpm and about 500 rpm and may be selected to achieve a desired pressure, temperature, blending profile, and/or speed of conveyance of a material in the barrel. As the at least one screw or auger rotates, material is conveyed along the length of the barrel from a feeding end to an orifice end. The extruder may also be a ram extruder, wherein a ram or plunger forces a material through one or more barrels toward an orifice end. The orifice of the extruder may include a nozzle, die, or any other opening with a profile, or physical and/or chemical characteristics designed to achieve a desired result. The extruder may include or have associated with it at least one heating element, configured to heat the material in the barrel or barrels. One way of achieving superheating and instantaneous boiling involves the use of a tapered nozzle to build up a back-pressure in the extruder. The taper helps to ensure that the pressure in the extruder is such that superheating of liquid in the MSW is maintained until the MSW reaches the exit of the nozzle.

By way of a non-limiting example, FIG. 6 shows a method 600 of converting garbage into thermoplastic employing step 610—feeding wet raw MSW into an extruder. This can occur in any manner, as long as wet raw MSW is provided to the extruder inlet. For example, FIG. 1 and FIG. 2 illustrate an exemplary system and processor for converting garbage to thermoplastic wherein wet raw MSW 102 is fed via hopper 106 into an extruder chamber 110 of an extruder. As another example, FIG. 5 illustrates an exemplary system and processor for converting feed waste (garbage) to a thermoplastic wherein wet raw MSW 502 is fed via feeding zone 506 into an extruder.

Some disclosed embodiments involve compressing wet raw municipal solid waste in an extruder to a pressure level above atmospheric pressure. Compressing refers to applying pressure or force. Compressing may reduce the size, volume, or amount of a material. Compressing may condense or compact a material. Compressing in an extruder refers to applying force to a material being processed within a barrel of the extruder. This force may be exerted by a revolving screw auger, which compresses the material along the length of the barrel. In some embodiments, compressing in an extruder increases a pressure level of the material in the barrel. In some embodiments, a pressure level of the material in the barrel is between about 1MPa and 50 MPa. In some embodiments, a pressure level of the material in the barrel is between about 12 MPa and 18 MPa. Compressing in an extruder may aid in blending and homogenizing a raw material fed into the extruder. Compressing may aid in mixing and shearing a raw material fed into the extruder. Compressing in an extruder may increase a temperature of a raw material fed into the extruder, thereby aiding in softening or melting the material to a desired consistency. Pressure level refers to a measurable pressure exerted on a material as described and exemplified elsewhere herein. The pressure level may be a range of pressures sufficient to maintain superheating of liquid in the MSW. Atmospheric pressure refers to ambient pressure as defined and exemplified elsewhere herein.

By way of a non-limiting example, FIG. 6 shows a method 600 of converting garbage into thermoplastic employing step 620-compressing wet raw municipal solid waste in an extruder to a pressure level above atmospheric pressure. Compressing may occur in any device capable of pressure elevation. Examples of extruders include hydraulic presses, piston-cylinder systems, screw presses, pneumatic systems, hydrostatic pressure systems, or any other system or device capable of causing pressure increase. By way of non-limiting examples, FIG. 1 and FIG. 2 illustrate exemplary systems and processes for converting garbage to thermoplastic wherein wet raw MSW in an extruder chamber 110 of an extruder is compressed by a revolving screw auger 112 to a first pressure level. Similarly, FIG. 3 illustrates a method 300 by which a water-material mixture 310 of wet raw MSW is pressurized to a first pressure level in extruder chamber 110 by revolving screw auger 112 to form a compressed mixture 320. As another example, FIG. 5 illustrates an exemplary system and processor for converting feed waste (garbage) to a thermoplastic wherein wet raw MSW 502 conveyed through a conveying zone 518 of an extruder chamber by screw auger 512. The revolving screw auger causes mixing and shearing 520 of the wet raw MSW in the conveying zone until a point wherein a pressure seal 521 is formed between the melted MSW and a wall of the extrusion chamber. The revolving screw auger also causes compression of the MSW in the extruder, such as in the compression and pressurization zone 522 downstream of the pressure seal 521.

Some disclosed embodiments involve heating wet raw municipal solid waste in an extruder. Heating refers to the application of thermal energy as described and exemplified elsewhere herein. In some embodiments, during heating, a temperature of the wet raw MSW is raised to a temperature that causes a substantial portion of the MSW to become molten. In some embodiments, during heating, a temperature of the wet raw MSW is raised to between about 100° C. and about 400° C. Heating may occur in stages, with multiple separately controllable temperature zones along a length of an extruder, or with a single temperature zone in the extruder. In the case of the former, the temperature may increase along the length of the extruder toward the nozzle exit. Thermocouples may be associated with each zone to permit temperature control.

By way of a non-limiting example, FIG. 6 shows a method 600 of converting garbage into thermoplastic employing step 630—heating wet raw MSW in an extruder. For example, FIG. 1 and FIG. 2 illustrate an exemplary system and processor for converting garbage to thermoplastic wherein wet raw MSW in an extruder chamber 110 of an extruder is heated by heating element 108. Similarly, FIG. 3 illustrates a method 300 by which a water-material mixture 310 of wet raw MSW is heated in an extruder chamber 110 by revolving screw auger 112 and heating element 108 to form a heated mixture 320. (While FIG. 3 illustrates one example where the heating element 108 extends to the nozzle, this need not be the case. In some embodiments, the heating element may only be associated with the extruder and not the nozzle.) As another example, FIG. 5 illustrates an exemplary system and processor for converting feed waste (garbage) to a thermoplastic wherein wet raw MSW 502, fed via feeding zone 506 into an extruder, begins melting 516 as a result of heating element 508. As the wet raw MSW is conveyed through a conveying zone 518 of an extruder chamber by screw auger 512, it continues to be heated by heating element 508 and the revolving screw auger 512.

Some disclosed embodiments involve advancing wet raw municipal solid waste to a nozzle of an extruder for explosive cracking upon nozzle ejection. Advancing refers to moving in a particular direction. For example, advancing may imply progress or forward motion. In an extruder, advancing of the material in a barrel may result from the rotation of a screw auger in the barrel, which pulls the material away from a feed inlet and pushes it towards an outlet. An outlet of the extruder may include a nozzle. A nozzle refers to a component designed to control the direction or characteristics of a fluid flow, typically by accelerating, decelerating, or altering the stream of material flow. A nozzle includes at least one orifice through which material is ejected. A nozzle may have various shapes, sizes, and/or configurations depending on the design needs of the system or machine. As a non-limiting example, a nozzle may have a tapered or conical shape and/or an opening with a round cross-section. In an extruder, a nozzle may be a component through which material is discharged or ejected from a barrel. Nozzle ejection therefore refers to the discharging of material from within a barrel of an extruder through a component for allowing discharge flow.

Explosive refers to an event related to, characterized by, or operated by an explosion wherein explosion refers to a release of energy as defined and exemplified elsewhere herein. Cracking refers to a fragmenting or shearing process. For example, as superheated liquid in the MSW instantaneously boils, the resulting explosion causes the MSW to shear or fragment into individual pieces. Cracking may also involve the breaking of intermolecular and/or intramolecular bonds within a material. The result of cracking may be visible to the human eye as distinct particles of non-uniform shape, or separate units that include one or more of cracks, fissures, voids, or any other structure indicative of a process by which a material has been fragmented, partially or completely, into smaller units. Explosive cracking thereby refers to a process fragmenting or shearing as a result of a release of energy.

By way of a non-limiting example, FIG. 6 shows a method 600 of converting garbage into thermoplastic employing step 640—advancing wet raw MSW to a nozzle of the extruder for explosive cracking upon nozzle ejection. Advancing wet raw MSW to a nozzle can occur in differing ways, depending on extruder design. By way of non-limiting example, FIG. 1 and FIG. 2 illustrate an exemplary system and processor for converting garbage to thermoplastic wherein wet raw MSW 102 is advanced along an extruder chamber 110 by a revolving screw auger 112 towards a nozzle 114 which results in explosive cracking upon nozzle ejection to yield thermoplastic pellets such as composite material 116. Similarly, FIG. 3 illustrates a method 300 by which a water-material mixture 310 of wet raw MSW is conveyed through an extruder chamber 110 towards a nozzle 114 by revolving screw auger 112 to yield a heated and compressed mixture 320. Upon nozzle ejection, the heated and compressed mixture 320 experiences sudden depressurization and instant evaporation or explosion 330 which results in explosive cracking to yield cracked molecules 340. As another example, FIG. 5 illustrates an exemplary system and processor for converting feed waste (garbage) to a thermoplastic wherein wet raw MSW 502 is advanced and conveyed through a conveying zone 518 and a metering zone 524 by revolving screw auger 512 towards a nozzle 514. As the MSW exits through nozzle 514, instantaneous pressure reduction creates explosive cracking 528.

In some disclosed embodiments, a region of the extruder immediately upstream of an opening of a nozzle constitutes a sudden decompression zone causing explosive cracking. A region refers to an area or part of a larger space. The region immediately upstream of the opening is an area, which could be infinitesimally thin in width, a fraction of a millimeter in width, or a few millimeters in width, just inside the opening (i.e., on the inside of the nozzle, just adjacent the opening through which material exits, upstream referring to a direction opposite from that in which a material flows). This area, where the pressure instantaneously drops to atmospheric pressure may be characterized as a sudden decompression zone. The presence of a sudden decompression zone may be characterized by explosions. That is, when explosions occur as the result of instantaneous boiling near the end of the nozzle, the location where those explosions begin may be referred to as a sudden decompression zone.

By way of a non-limiting example, FIG. 5 illustrates an exemplary system and processor for converting feed waste (garbage) to a thermoplastic wherein wet raw MSW 502 is advanced toward a nozzle 514 by a revolving screw auger 512. Immediately prior to ejection through nozzle 114, the melted MSW moves through sudden decompression zone 526, wherein instantaneous pressure reduction creates explosive cracking 528.

Some disclosed embodiments involve injecting a liquid into an extruder. Injecting refers to supplying or introducing an input into a system or equipment at a particular time or location. Equipment for injecting may include pumps, hoses or tubing, nozzles, valves, gauges, and any other equipment useful in conveying, regulating, and/or administering an input into a system or equipment as desired for the design requirements of the system or equipment. Injection may occur using a water valve set at a particular pressure threshold. When the pressure in extruder drops below the threshold, the valve may automatically open. Alternatively, liquid may be introduced on a periodic basis, when a moisture content is detected as falling below a threshold, or continuously. In some embodiments, liquid is injected at a sufficient time in the process of converting garbage to thermoplastic and/or at a sufficient location along the length of the extruder used in the process such that the liquid is substantially absorbed by a material in a barrel of the extruder prior to nozzle ejection, wherein “substantially absorbed” is described and exemplified elsewhere herein.

In some embodiments, liquid can be added in any point through a method or system for converting garbage to thermoplastic by injection nozzle. In an instance where the moisture of the garbage (MSW) is higher than 8%, injection of liquid may not be required. When the liquid exists almost evenly inside heated MSW, the explosion of micro water drops or water molecule clusters will occur at any space inside the melted MSW, causing internal shearing forces which break apart particles and may also break intermolecular bonds.

By way of a non-limiting example, FIG. 2 illustrates an exemplary system and processor wherein liquid is injected into an extruder chamber 110 of an extruder via injection nozzle 104. Similarly. FIG. 5 illustrates an exemplary system and processor for converting feed waste (garbage) to a thermoplastic in an extruder wherein liquid is injected into the extruder by liquid feed 504. The extruder may also include excess liquid drain 510 upstream of the liquid feed 504. Although liquid drain 510 is illustrated in a bottom portion of the wall of extruder chamber 509, the drain 510 could be located in the side of the wall. Locating the drain in the side of the wall, may prevent MSW in the pressure chamber from blocking the drain. To achieve this goal the drain may be located above a screw level in the extruder chamber 509.

In some embodiments, the liquid inlet ensures that sufficient moisture is present in the MSW so that, upon exit from the extruder, cracking (instantaneous boiling, micro-explosions, and evaporation) occurs.

The design of the liquid inlet may vary based on several factors including, for example, the type of extruder which is being used, the type screws (size and shape), the source of liquid, and the characteristics of MSW which is used. All these factors may affect the location of an inlet in an extruder and the way the inlet is controlled. In some embodiments, the liquid inlet may utilize a unidirectional flow valve, which allows liquid to flow only to one direction into the extruder.

In some embodiments, the liquid inlet valve may be of any type of valve, including a ball valve, a globe valve, a clapper valve, a check valve, etc. In some embodiments, the liquid inlet valve is made of heat-withstanding material (such as brass, stainless steel, cast iron, bronze etc.). In some embodiments, the liquid inlet valve may be placed directly over the inlet. In some embodiments, the liquid inlet valve may be attached to the extruder. In some embodiments, the liquid inlet valve may be detached from the extruder, such as connected through a durable water pipe to the inlet.

In some embodiments, the liquid inlet may be connected to the municipal water system, which has a positive delivery pressure. In some embodiments, when combined with a specific type of screw auger (e.g., a screw auger having several intake stages), the liquid inlet may not need an active control system. Instead, the liquid inlet may rely on the difference in pressure between the source (e.g., the municipal water system) and the extruder to add the liquid to the extruder. In some embodiments, a pump or other active components may add the liquid into the melted MSW mixture in the extruder.

In some embodiments, the location of the inlet valve along the extruder facilitates substantial absorption of the liquid into the MSW mixture in order to achieve a desired a cracking effect. Without wishing to be bound by theory, it was discovered that internal moisture and external moisture and may have different effects on the cracking effect. For example, internal moisture may cause cracking inside the material. External moisture may affect the escape velocity of the material exiting the nozzle, but only may have limited effect on the properties of the material itself.

In some embodiments, liquid may be provided to the MSW by a watering/moisturizing system placed before the MSW is fed into the extruder chamber. For example, the watering/moisturizing system may be placed in the raw MSW, such as after it has been optionally shredded, or liquid may be added in the hopper.

In some embodiments, a source of the liquid may be a municipal water system or a retrieved water system (i.e., local to the factory or from a zone retrieval). In some embodiments, a source of the liquid source may be stored backflow of excess MSW water. In some embodiments, the chemical characteristics of the liquid can vary. Therefore, in some embodiments, there is no need for consistency nor preparations. Similarly, in some embodiments, liquid temperature may vary and, therefore, no-preheating or cooling is necessary.

In some embodiments, when there is oversaturation of liquid in the MSW, the system might create liquid backflow. As a non-limiting example, oversaturation of liquid in the MSW may occur when the MSW includes over 70% liquid by weight. Backflow may impact the efficiency of the system. Therefore, in some embodiments, excess liquids may be removed from the system or process of converting MSW to a thermoplastic composite material. This removal of excess liquid may improve overall efficiency. In some embodiments, liquid is removed from an extruder by a liquid backflow drain. Modifications to include liquid drains are not typical for extruders. In some embodiments, the liquid backflow drain may be added to the barrel on top of evacuation holes which typically exist in plastic extruders. One or more drains may be placed above an expected MSW level in the extruder so that water flowing over the top of the MSW may exit the extruder without the MSW blocking the drain.

In some embodiments, a position of the liquid drain is at the inlet end of the barrel. In some embodiments, a position of the liquid drain is above screw level but below the maximum barrel height. In some embodiments, the liquid drain may include a cover or seal which can be removed when needed, to allow the excess fluids to be released.

In some embodiments, a resin comprising a plurality of thermally cracked fragments of thermoplastic material is provided, wherein each fragment has an irregular shape, an irregular size, an irregular surface area, flakes and whiskers extending therefrom, and wherein the plurality of thermally cracked fragments are heat-deformable for use in manufacture of thermoplastic goods. In some embodiments, the resin comprising a plurality of thermally cracked fragments of thermoplastic material is formed from at least one method or process of converting MSW to thermoplastic described and exemplified elsewhere herein. In some embodiments, the form of the thermally cracked fragments is a direct result of these processes (e.g., the micro-explosions). In some embodiments, the form of the thermally cracked fragments is not a result of post-extrusion cutting or grinding.

In some embodiments, the plurality of thermally cracked fragments includes different sizes including puffed nuggets (15-100 mm in size), flakes (3-15 mm in size), and/or powder (less than 3 mm in size).

In some embodiments, the plurality of thermally cracked fragments includes flakes of matter in different shapes, sizes, and colors. Flakes may be of different matter and/or origin. Flakes may come in a loose formation or in a coagulated manner. In some embodiments, the plurality of thermally cracked fragments includes whiskers which may be matter in the form of fibers. In some embodiments, the whiskers are fully or partially attached to a nucleus of a fragment. Whiskers may be straight or curly. Whiskers may be of different colors and sizes. Whiskers may be of different matter and/or origin. Whiskers may be twirled with each other. Whiskers may be in a dense or a loose formation.

In some embodiments, the plurality of thermally cracked fragments includes visible particulate matter non-uniformly embedded therein. In some embodiments, the visible particulate matter includes at least one material selected from metal, glass, ceramics, or composites. In some embodiments, the visible particulate matter is of different size and shape. In some disclosed embodiments, the visible particulate matter retains its original size or shape from before thermal cracking. In some disclosed embodiments, the visible particulate matter has a size or shape which differs from its size or shape prior to thermal cracking.

In some embodiments, the plurality of thermally cracked fragments are gray, black, brown, green, a combination thereof in color, or other colors depending on the types and colors of waste used. In some embodiments, the color is variable from fragment to fragment. In some embodiments, the gray color is variable from fragment to fragment. In some embodiments, the black color is variable from fragment to fragment. In some embodiments, the brown color is variable from fragment to fragment. In some embodiments, the green color is variable from fragment to fragment.

Some disclosed embodiments involve an extruder nozzle adapted for causing municipal solid waste cracking. Aspects of which were described and exemplified previously.

In some disclosed embodiments, the nozzle is made of a material which can withstand high temperature, abrasion, and pressure. Some examples of materials for a nozzle include metal and ceramic. Metal refers to a materials and their alloys, on the left side of the periodic table, which are thermally conductive. Examples of metal include copper, iron, aluminum, gold, silver, zinc, titanium, and combinations thereof. Metal may also refer to mixtures of at least two elements, wherein at least one is a metal. Examples of alloys include brass, steel, stainless steel, an aluminum alloys. In some disclosed embodiments, the nozzle is brass. Brass refers to an alloy of copper and zinc.

In some disclosed embodiments, a length of the nozzle is greater than 4 cm. Length refers to a measurement of physical dimension from an inlet end to an outlet end. Greater than refers to a mathematical comparison, indicating that one quantity is higher than another. Greater than may also include equal to. In some disclosed embodiments, a length of the nozzle is greater than10 cm. The length of the nozzle may vary from these values and may be determined based on the design needs of the system for achieving certain product sizes and pressure levels.

A nozzle adapted for causing municipal solid waste cracking refers to the nozzle being either specifically designed or specifically selected so as to cause municipal solid waste to crack when the nozzle is in the claimed use. For example, a nozzle is adapted to cause municipal solid waste to crack when the nozzle orifice and bore are sized so to maintain a pressure within an extruder sufficient to cause superheating of the liquid in the MSW, while exposing the MSW to atmospheric pressure on at the exit end of the nozzle. In some embodiments, this occurs through the incorporation of a taper in the nozzle, or with a nozzle that has a cross-sectional area smaller than a cross-sectional area of an extruder barrel. As the result, a back-pressure will build in the nozzle, maintaining the superheated nature of the liquid in the MSW until just before the MSW reaches the orifice.

By way of a non-limiting example, FIG. 7A and FIG. 7D illustrate exemplary cross sections of a nozzle 114 adapted for MSW cracking. FIG. 1 and FIG. 2 show an illustration of an exemplary system and processor for cracking MSW 102 which include a nozzle 114.

Some disclosed embodiments involve an extruder nozzle comprising an inlet end configured for connection to an extruder barrel. An inlet end refers to an entry location. For instance, inlet may refer to an opening that allows the ingress of something. End refers to a boundary point of an object. End may refer to an extremity or terminal point of an object. For instance, end may refer to the outermost or final part of an object in terms of length, width, or height. Inlet end thereby refers to a boundary point of an object which serves as an entry point.

A nozzle configured for connection to an extruder barrel refers to the adaption of the nozzle to fit on the outlet end of an extruder barrel. This may occur if the extruder barrel and the nozzle are integrally formed, if the two are threaded for screw connection, or if the two can be bolted or otherwise fastened together. Connections may employ fasteners such as nuts, bolts, screws, rivets, or any other mechanical device for joining two or more objects. Connections may include fittings such as connectors, valves, and couplings. Connections may employ welding, wherein metal parts are joined by melting and fusing the parts together. Connections may employ adhesives or other bonding agents to physically connect surfaces. The adhesives may be applied directly to at least one surface of the two or more objects. The adhesives may also be applied via a carrier, such as a textile or film (i.e., a tape).

An extruder barrel refers to an at least partially enclosed compartment and/or cavity in an extruder. A barrel may have a cylindrical shape or a bore. Extruder An extruder barrel may be made of a durable, heat resistant material. An auger (also known as a screw) may be rotatably mounted in the extruder barrel for forcing a material therethrough.

In some disclosed embodiments, the inlet end of the nozzle is threaded for screw connection to the extruder barrel. Threaded refers to an object having spiral ridges. The spiral ridges allow a threaded object to be rotated into or onto a corresponding threaded part. Threaded for screw connection refers to an object having spiral ridges which may be connected with a corresponding part having spiral ridges by rotating the two parts together to form a secure attachment.

In some disclosed embodiments, the nozzle is removable from the extruder barrel. Removable refers to a characteristic of being detachable from another object or system, in this case, the extruder barrel. Removable may imply flexibility and ease of detachment of one object from another object or system without causing significant disruption, damage, or permanent alteration to the other object or system.

By way of a non-limiting example, FIG. 7A and FIG. 7D illustrate exemplary cross sections of a nozzle 114 adapted for MSW cracking including an inlet end 702 configured for connection to an extruder barrel. FIG. 7D also shows a spiral-ridged region 709 at the inlet end 702 by which nozzle 114 is threaded for screw connection to an extruder barrel (not shown). FIG. 1 and FIG. 2 show an illustration of an exemplary system and processor for cracking MSW 102 which include a nozzle 114 connected to an extruder barrel (or chamber) 110 via an inlet end of the nozzle 114. Similarly, FIG. 7B shows cross section of a portion of an exemplary system and processor for cracking MSW which includes a nozzle 114 connected to an extruder barrel (or chamber) 110 via an inlet end 702 of the nozzle.

In some disclosed embodiments an extruder nozzle has an outlet end configured for expelling fragments of cracked municipal waste. An outlet end refers to a boundary location which serves as an exit. Expelling refers to the ejection or forcing out of something. Fragments refers to a piece or portion. For instance, a fragment may be a piece or portion of a larger mass of material. Fragments may be formed by breaking or separating. Fragments may be formed by explosions. Cracked refers to pieces that are fragmented or sheared, as described and exemplified elsewhere herein.

By way of a non-limiting example, FIG. 7A and FIG. 7D illustrate exemplary cross sections of a nozzle 114 adapted for MSW cracking, including an outlet end 704. FIG. 7D further illustrates an exemplary cross section of a nozzle 114 including an outlet end 704 configured for expelling fragments of cracked municipal solid waste (composite material 116). FIG. 1 and FIG. 2 show an illustration of an exemplary system and processor for cracking MSW 102 which include a nozzle 114 configured to expel fragments of cracked municipal solid waste 116 via an outlet end. Similarly, FIG. 7B shows a cross section of a portion of an exemplary system and processor for cracking MSW which includes a nozzle 114 having an outlet end 704 configured to expel fragments of cracked municipal solid waste 116.

Some disclosed embodiments involve an auger-free compression zone proximate an inlet end, the auger-free compression zone having a first cross-sectional area. Auger-free refers to a space or area without an auger and a compression zone refers to an area where higher than atmospheric pressure is either maintained or increased. When force is applied to a material, pressure may increase and volume may be reduced. Depending on embodiment, some compression zones may be associated with an obstruction, a bottleneck, or a restriction, limiting flow or increasing the pressure of flow. Liquids are typically considered to be incompressible under normal conditions although extreme pressures or specific conditions can lead to some compression in liquids. Solids are compressible and the compression may materialize as a decrease in volume or deformation of shape, depending on the specific material properties. Zone refers to a particular area. Compression zone therefore refers to an area in which pressure increases. A compression zone is an auger-free compression zone when no auger (or no auger blade) exists within the zone. The portion of the nozzle proximate (e.g., near) the inlet end has a first cross-sectional area. This area is in contrast to a second cross-sectional area, discussed later, that is smaller and which, as a result, facilitates the maintenance of appropriate pressure in the nozzle.

A cross-sectional area is a two-dimensional amount of space measured, for example in square inches (in²). For a nozzle, a cross-sectional area may refer to a two-dimensional amount of space of a shape of the opening when cut by a plane at a right angle.

In some disclosed embodiments, the extruder barrel has a bore opening. An extruder barrel refers to a compartment and/or cavity through which a material is forced as described and exemplified elsewhere herein. An extruder barrel may include an outlet. A bore opening refers to an internal diameter, width, size, or cross-section of a hole or tube. In the context of an extruder barrel, a bore opening may refer to an internal diameter, width, size, or cross section of the barrel's outlet. In some disclosed embodiments, a cross-sectional area of the compression zone corresponds to the bore opening. Corresponds refers to a relationship, similarity, or equivalence to something else. As a non-limiting example, a cross-sectional area of the compression zone corresponding to the bore opening of the extruder may be equivalent to the bore opening of the extruder.

By way of a non-limiting example, FIG. 7A, FIG. 7B, and FIG. 7D illustrate exemplary cross sections of a nozzle 114 including an auger-free compression zone 706 proximate an inlet end 702. The auger-free compression zone 706 has a first cross-sectional area. As illustrated by FIG. 7B, the auger-free compression zone 706 may be proximate a heating and mixing zone 701 of an extruder chamber (i.e. barrel) 110.

Some disclosed embodiments involve a tapered zone, between an auger-free compression zone and an outlet end, the tapered zone progressively reducing in cross-sectional area from the compression zone to the outlet end, such that a second cross-sectional area at the outlet end is smaller than the first cross-sectional area. A tapered zone refers to an area in which an object gradually becomes narrower or thinner toward one end. Progressively reducing in cross-sectional area refers to gradually or in a step-by-step manner becoming smaller. Thus, in the area between the outlet of the nozzle and the compression zone, the bore of the nozzle tapers to become smaller in size, such that a second cross-sectional area in the tapered zone (e.g., the cross-sectional area at the outlet opening) is smaller than the first cross-sectional area of the compression zone.

In some embodiments, the compression zone has a length of about 10 mm to about 40 mm. In some embodiments, the tapered zone has a length of about 10 mm to about 20 mm. In some disclosed embodiments, the compression zone has a length larger than a length of the tapered zone. Length refers to a measurement of physical dimension as described and exemplified elsewhere herein. Larger refers to greater in size, extent, quantity, degree, or intensity. Thus, the length along the axis of the bore in the nozzle is greater in the compression zone than in the tapered zone.

In some disclosed embodiments, the extruder nozzle includes a ledge in the tapered zone. A ledge refers to a narrow, shelf-like structure. A ledge may be nearly flat or completely flat. In some embodiments, the ledge may have a height of about 2 mm to about 10 mm. In some embodiments, the ledge may have a length of about 10 mm to about 20 mm. In some disclosed embodiments, a size of the ledge is less than 90% of the tapered zone. Size refers to a dimension, extent, or magnitude of an object. Size may be defined in terms of a one-dimensional measurement such as height, width, or length. Size may be defined in terms of a two-dimensional measurement such as area. Size may be defined in terms of a three-dimensional measurement such as volume. Less than refers to a mathematical comparison, indicating that one quantity is lower than another. Less than may also include equal to. In some disclosed embodiments, a size of the ledge is less than60% of the tapered zone.

By way of a non-limiting example, FIG. 7A and FIG. 7B illustrate exemplary cross-sections of a nozzle 114 including a tapered zone 708 between an auger-free compression zone 706 and an outlet end 704. The tapered zone 708 progressively reduces in cross-sectional area from the auger-free compression zone 706 to the outlet end 704, such that a second cross-sectional area at the outlet end 704 is smaller than a first cross-sectional of the auger-free compression zone 706. By way of another non-limiting example, FIG. 7D illustrates an exemplary cross-section of a nozzle 114 including an inlet end 702, a tapered zone 708 between an auger-free compression zone 706 and an outlet end 704 configured for expelling fragments of cracked municipal solid waste (composite material 116). The nozzle 114 may include at least one ledge 710 in the tapered zone 708. In some embodiments, an edge of ledge 710 may align with the transition from the compression zone 706 to the tapered zone 708.

Some disclosed embodiments involve an extruder nozzle including a second cross-sectional area smaller than a first cross-sectional area to thereby enable a pressure increase in a tapered zone for facilitating micro-explosions in municipal solid waste upon exit from an outlet end. Enabling a pressure increase refers to making possible. The fact that the second cross-sectional area of the tapered zone of the nozzle is smaller than the first cross-sectional area of the compression zone, increases the pressure in the tapered zone as the result of increase resistance to flow. Thus, the pressure remains high enough in the nozzle so that explosions only occur when the outermost MSW is exposed to atmospheric pressure at the outlet end of the nozzle. This facilitates (e.g., helps to achieve the result of) micro explosions at the outlet end.

By way of a non-limiting example, FIG. 7A and FIG. 7B illustrate exemplary cross sections of a nozzle 114 including a second cross-sectional area at the outlet end 704 smaller than a first cross-sectional of the auger-free compression zone 706 to thereby facilitate a pressure increase in the tapered zone 708. FIG. 7B illustrates that this pressure increase in the tapered zone 708 may facilitate micro-explosions in the MSW upon exit from an outlet end 704 of the nozzle 114. FIG. 7C is a diagram of an exemplary phenomenon involved in the nozzle 114 whereby pressure increases in the nozzle 114 described and exemplified herein result in a series of explosions of the MSW upon exit from an outlet end wherein each explosion in the series of explosions includes a start point and a freeze point.

In some embodiments, the extruder barrel has a length of about 300 mm to about 1,800 mm. In some embodiments, the extruder barrel has a diameter in a range of about 10 to 300 mm. In some embodiments, the outlet end of the nozzle has a diameter in a range of about 8 to 25 mm. In some disclosed embodiments, the extruder barrel has a third cross-sectional area and a ratio of the second cross-sectional area at the outlet end of the nozzle to the third-cross sectional area of the extruder barrel is about 1:1.25 to 1:12. In some disclosed embodiments, the ratio of the second cross-sectional area at the outlet end of the nozzle to the third-cross sectional area of the extruder barrel is about 1:3 to 1:8.

In some disclosed embodiments, the extruder barrel has a throughput of municipal solid waste and wherein the second cross-sectional area at the outlet end enables micro-explosions in the municipal solid waste upon exit from the outlet end at the throughput. Throughput refers to material exiting the nozzle. The smaller cross-sectional area in the tapered zone permits the explosions to occur as the material exits the nozzle (as opposed, for example, to exploding near the inlet end of the nozzle).

In some disclosed embodiments, the extruder nozzle is adapted for causing municipal solid waste cracking of municipal solid waste having a maximum size, and wherein the second cross-sectional area at the outlet end is larger than the maximum size. A maximum size refers to an upper limit in dimension. The maximum size of MSW may be controlled by pre-processing an MSW stream. For example, an MSW stream may be ground or shredded such that the pieces entering the extruder are no larger than a maximum desired size. By ensuring that the second cross-sectional area is greater than the maximum size, it is possible to prevent clogging of the nozzle.

In some disclosed embodiments, the second cross-sectional area at the outlet is at least 10% greater than the maximum size. Greater than refers to a mathematical comparison, indicating that one quantity is higher than another as described and exemplified elsewhere herein. In some disclosed embodiments, the second cross-sectional area at the outlet is no more than 50% greater than the maximum size.

In some disclosed embodiments, the extruder further includes at least one additional extruder nozzle adapted for causing municipal solid waste cracking having an inlet end configured for connection to the extruder barrel of the extruder. The additional extruder nozzle is a second nozzle. In some embodiments, at least two nozzles may be associated with the same barrel. In another embodiment, multiple barrels may be employed, with each barrel having its own nozzle.

By way of a non-limiting example, FIG. 7E shows an exemplary system for making thermoplastic from municipal waste wherein mixture of raw waste 102 is fed into a hopper 106, compressed and heated in extruder chamber 110 by revolving screw auger 112 and heating element 108, and optionally moisturized by injecting fluid into the extruder chamber 110 using injection nozzle 104. Attached to extruder chamber (i.e. barrel) 110 may be a plurality of nozzles, such as the three nozzles 114 illustrated in FIG. 7E. Each nozzle 114 may eject thermoplastic formed from MSW. For instance, the extruder may include two nozzles, or more than three nozzles.

Examples of inventive concepts are contained in the following clauses which are an integral part of this disclosure.

Clause 1. A method of converting raw municipal solid waste (MSW) to a composite material with thermoplastic properties, the method comprising: heating the MSW having a liquid content to a first pressure level, the first pressure level being sufficient to enable a temperature of the MSW to exceed an atmospheric boiling temperature of the liquid content, and
instantaneously reducing the first pressure level of the heated MSW to a second pressure level to: enable the liquid content to instantaneously boil;
instantaneously cause evaporation of substantially all the liquid content; and
transform the heated MSW into the composite material having thermoplastic properties.

Clause 2. The method of clause 1, wherein the instantaneous boiling and the instantaneous evaporation are manifest in an explosion.

Clause 3. The method of any of clauses 1 to 2, wherein the method further includes causing a series of explosions in succession.

Clause 4. The method of any of clauses 1 to 3, wherein the liquid content is between about 6% by weight of the raw MSW and about 80% by weight of the raw MSW.

Clause 5. The method of any of clauses 1 to 4, wherein the liquid content is at least about 30% of the raw MSW by weight.

Clause 6. The method of any of clauses 1 to 5, wherein the liquid content is a combination of the liquid present in the raw MSW and a supplemental volume of liquid added during the heating or before the heating.

Clause 7. The method of any of clauses 1 to 6, wherein the liquid content is substantially absorbed by the heated MSW prior to the instant pressure reduction.

Clause 8. The method of any of clauses 1 to 7, wherein the second pressure level is atmospheric pressure.

Clause 9. The method of any of clauses 1 to 8, wherein during heating, the temperature of the MSW is raised to between about 100° C. and about 400° C.

Clause 10. The method of any of clauses 1 to 9, wherein the raw MSW includes a plastic content and a non-plastic content and wherein the non-plastic content includes at least one persistent material selected from metal, glass, thermoset polymer, and rock.

Clause 11. The method of any of clauses 1 to 10, wherein the instantaneous pressure reduction causes at least some of the persistent material be capsulized and embedded in the composite material.

Clause 12. The method of any of clauses 1 to 11, wherein properties of the composite material enable the composite material to be plastically formed into products.

Clause 13. A composite material having thermoplastic properties, and being formed from a municipal solid waste (MSW) stream including papers, plastics, metals, glass, and organics, the composite material being made via a process, comprising:
heating the MSW having a liquid content to a first pressure level, the first pressure level being sufficient to enable a temperature of the MSW to exceed an atmospheric boiling temperature of the liquid content, and
instantaneously reducing the first pressure level of the heated MSW to a second pressure level to:
enable the liquid content to instantaneously boil;
instantaneously cause evaporation of substantially all the liquid content; and
transform the heated MSW into the composite material having thermoplastic properties.

Clause 14. The composite material having thermoplastic properties of any of clauses 1 to 13, wherein the composite material has a fibrous and flaky structure.

Clause 15. The composite material having thermoplastic properties of any of clauses 1 to 14, wherein the composite material is porous.

Clause 16. A method of turning garbage into thermoplastic, the method comprising: feeding wet raw municipal solid waste into an extruder;
compressing the wet raw municipal solid waste in the extruder to a pressure level above atmospheric pressure;
heating the wet raw municipal solid waste in the extruder; and
advancing the wet raw municipal waste to a nozzle of the extruder for explosive cracking upon nozzle ejection.

Clause 17. The method of any of clauses 1 to 16, wherein a liquid content of the wet raw municipal solid waste is at least about 6% by weight.

Clause 18. The method of any of clauses 1 to 17, wherein the method further comprises injecting a liquid into the extruder.

Clause 19. The method of any of clauses 1 to 18, wherein during the heating, a temperature of the wet raw municipal solid waste is raised to between about 100° C. and about 400° C.

Clause 20. The method of any of clauses 1 to 19, wherein a region of the extruder immediately upstream of an opening of the nozzle constitutes a sudden decompression zone causing the explosive cracking.

Clause 21. An extruder nozzle adapted for causing municipal solid waste cracking as set forth in this clause or in combination with one or more of the preceding clauses, the extruder nozzle comprising:
an inlet end configured for connection to an extruder barrel;
an outlet end configured for expelling fragments of cracked municipal waste;
an auger-free compression zone proximate the inlet end, the auger-free compression zone having a first cross-sectional area; and
a tapered zone, between the auger-free compression zone and the outlet end, the tapered zone progressively reducing in cross-sectional area from the compression zone to the outlet end, such that a second cross-sectional area at the outlet end is smaller than the first cross-sectional area, to thereby enable a pressure increase in the tapered zone for facilitating micro-explosions in the municipal solid waste upon exit from the outlet end.

Clause 22. The extruder nozzle of any of clauses 1 to 21, wherein nozzle is removable from the extruder barrel.

Clause 23. The extruder nozzle of any of clauses 1 to 22, wherein the inlet end of the nozzle is threaded for screw connection to the extruder barrel.

Clause 24. The extruder nozzle of any of clauses 1 to 23, wherein the inlet end of the nozzle is metal.

Clause 25. The extruder nozzle of any of clauses 1 to 24, wherein the extruder nozzle is brass.

Clause 26. The extruder nozzle of any of clauses 1 to 25, wherein the extruder barrel has a bore opening and wherein a cross-sectional area of the compression zone corresponds to the bore opening.

Clause 27. The extruder nozzle of any of clauses 1 to 26, wherein the extruder barrel has a third cross-sectional area and a ratio of the second cross-sectional area at the outlet end of the nozzle to the third-cross sectional area of the extruder barrel is about 1:1.25 to 1:12.

Clause 28. The extruder nozzle of any of clauses 1 to 27, wherein the ratio of the second cross-sectional area at the outlet end of the nozzle to the third-cross sectional area of the extruder barrel is about 1:3 to 1:8.

Clause 29. The extruder nozzle of any of clauses 1 to 28, wherein the extruder barrel has a throughput of municipal solid waste and wherein the second cross-sectional area at the outlet end enables micro-explosions in the municipal solid waste upon exit from the outlet end at the throughput.

Clause 30. The extruder nozzle of any of clauses 1 to 29, wherein the compression zone has a length larger than a length of the tapered zone.

Clause 31. The extruder nozzle of any of clauses 1 to 30, further comprising a ledge in the tapered zone.

Clause 32. The extruder nozzle of any of clauses 1 to 31, wherein a size of the ledge is less than 90% of the tapered zone.

Clause 33. The extruder nozzle of any of clauses 1 to 32, wherein a size of the ledge is less than 60% of the tapered zone.

Clause 34. The extruder nozzle of any of clauses 1 to 33, wherein a length of the nozzle is greater than 4 cm.

Clause 35. The extruder nozzle of any of clauses 1 to 34, wherein the length of the nozzle is greater than 10 cm.

Clause 36. The extruder nozzle of any of clauses 1 to 35, wherein the extruder nozzle is adapted for causing municipal solid waste cracking of municipal solid waste having a maximum size, and wherein the second cross-sectional area at the outlet end is larger than the maximum size.

Clause 37. The extruder nozzle of any of clauses 1 to 36, wherein the second cross-sectional area at the outlet is at least 10% greater than the maximum size.

Clause 38. The extruder nozzle of any of clauses 1 to 37, wherein the second cross-sectional area at the outlet is no more than 50% greater than the maximum size.

Clause 39. The extruder nozzle of any of clauses 1 to 38, further comprising the extruder, connected to the nozzle.

Clause 40. The extruder nozzle of any of clauses 1 to 39, wherein the extruder further comprises at least one additional extruder nozzle adapted for causing municipal solid waste cracking having an inlet end configured for connection to the extruder barrel of the extruder. Clause 41. A material (resin) as set forth in this clause or in combination with one or more of the preceding clauses, comprising:
a plurality of thermally cracked fragments of thermoplastic material, each fragment having an irregular shape, an irregular size, an irregular surface area, flakes and whiskers extending therefrom, and wherein the plurality of thermally cracked fragments are heat-deformable for use in manufacture of thermoplastic goods.

Clause 42. The material of any of clauses 1 to 41, wherein the plurality of thermally cracked fragments include visible particulate matter non-uniformly embedded therein.

Clause 43. The material of any of clauses 1 to 42, wherein the visible particulate matter includes at least one material selected from metal, glass, ceramics or composites.

Clause 44. The material of any of clauses 1 to 43, wherein the visible particulate matter is of different size and shape.

Clause 45. The material of any of clauses 1 to 44, wherein the visible particulate matter is fully encapsulated in the resin, partly connected to the resin particles, or fully detached from the resin particles.

Clause 46. The material of any of clauses 1 to 45, wherein the visible particulate matter has kept its original size or shape or not.

Clause 47. The material of any of clauses 1 to 46, wherein the plurality of thermally cracked fragments are green, gray, black, or brown in color.

Clause 48. The material of any of clauses 1 to 47, wherein the gray color is variable from fragment to fragment.

Clause 49. The material of any of clauses 1 to 48, wherein the black color is variable from fragment to fragment.

Clause 50. The material of any of clauses 1 to 49, wherein the brown color is variable from fragment to fragment.

Clause 51. The material of any of clauses 1 to 50, wherein there is a combination of colors and is variable from fragment to fragment.

Clause 52. The material of any of clauses 1 to 51, wherein the plurality of thermally cracked fragments are of different shapes sizes.

Clause 53. The material of any of clauses 1 to 52, wherein the resin is of different sizes and shapes, from the shape and size of a puffed nuggets (15-100 mm of size), flakes (3-15 mm) or powder (<3 mm).

Clause 54. The material of any of clauses 1 to 53, wherein the plurality of thermally cracked fragments are a direct result of the methods and apparatuses disclosed herein, and depends directly on the pressure defined in the process, and not by cutting or grinding.

Clause 55. The material of any of clauses 1 to 54, wherein the plurality of thermally cracked fragments include flakes and whiskers.

Clause 56. The material of any of clauses 1 to 55, wherein the resin has whiskers-a matter in the form of fibers, fully or partially attached to the nucleus of the resin.

Clause 57. The material of any of clauses 1 to 56, wherein the whiskers are straight or curly, and different colors and sizes.

Clause 58. The material of any of clauses 1 to 57, wherein the whiskers are of different matter, or origin.

Clause 59. The material of any of clauses 1 to 58, wherein the whiskers are twirled with each other, in a dense or a loose formation.

Clause 60. The material of any of clauses 1 to 59, wherein the resin has flakes of matter, in different shapes, sizes and colors.

Clause 61. The material of any of clauses 1 to 60, wherein the flakes are of different matter and origin.

Clause 62. The material of any of clauses 1 to 61, wherein the flakes have a loose formation or coagulated manner.

Clause 63. A system for converting raw municipal solid waste (MSW) to a thermoplastic composite material as set forth in this clause or in combination with one or more of the preceding clauses, the system comprising:
a barrel having an inlet end and an outlet end;
a nozzle, mounted on the outlet end;
an inlet opening in the barrel proximate the inlet end, the inlet opening being sized to receive a municipal solid waste mixture;
at least one screw auger rotatably mounted within the barrel, the at least one screw auger configured to cause a progressive pressure increase from the inlet end to the outlet end;
at least one motor connected to the at least one screw auger, for rotating the at least one screw auger in the barrel;
a fluid inlet in the barrel, between the inlet end and the outlet end, the fluid inlet being configured to admit fluid into the municipal solid waste mixture in the barrel; and
a heater thermally coupled to the barrel, the heater being configured to heat the municipal solid waste mixture and the admitted fluid while the at least one screw auger causes an increase in pressure above atmospheric pressure to thereby superheat the fluid.

Clause 64. The system of any of clauses 1 to 63, wherein the fluid inlet is a water inlet.

Clause 65. The system of any of clauses 1 to 64, further comprising a controller, for regulating the at least one motor to maintain a pressure in the barrel sufficient to prevent boiling of the fluid.

Clause 66. The system of any of clauses 1 to 65, wherein the controller is configured to maintain a pressure in the barrel between about 1 MPa and about 50 MPa.

Clause 67. The system of any of clauses 1 to 66, wherein the nozzle is sized to cause fragments of the municipal solid waste mixture to experience cracking upon ejection from the nozzle.

Clause 68. The system of any of clauses 1 to 67, wherein the fluid inlet is located in a region of the barrel midway between the inlet and the outlet.

Clause 69. The system of any of clauses 1 to 68, wherein the fluid inlet is located no more than three quarters of a length of the barrel from the inlet end.

Clause 70. The system of any of clauses 1 to 69, wherein the fluid inlet is located no more than half a length of the barrel from the inlet end.

Clause 71. The system of any of clauses 1 to 70, wherein the fluid inlet is configured for connection to a water supply.

Clause 72. The system of any of clauses 1 to 71, further comprising a valve associated with the fluid inlet, and a controller for monitoring fluid content in the chamber and regulating the valve in response thereto.

Clause 73. The system of any of clauses 1 to 72, wherein the controller is configured to regulate the valve to maintain a fluid content of between about 6% and 80% weight of the municipal solid waste mixture.

Clause 74. The system of any of clauses 1 to 73, further comprising a moisture sensor in the barrel, and wherein the controller is configured to monitor the fluid content via a connection to the moisture sensor.

Clause 75. The system of any of clauses 1 to 74, further comprising a thermocouple in the barrel, and wherein the controller is further configured to control the heater based on feedback from the thermocouple.

Clause 76. The system of any of clauses 1 to 75, further comprising a fluid outlet in the barrel.

Clause 77. The system of any of clauses 1 to 76, wherein the fluid outlet is axially positioned at a location in the barrel between the inlet end and the fluid inlet.

Clause 78. The system of any of clauses 1 to 77, wherein the at least one screw auger includes two screw augers.

Clause 79. The system of any of clauses 1 to 78, wherein the at least one motor includes two motors, each motor for separately rotating a differing screw auger.

Clause 80. The system of any of clauses 1 to 79, wherein the inlet opening sized to receive a municipal solid waste mixture is sized to receive the municipal solid waste mixture in shredded form.

Clause 81. A system for converting wet municipal solid waste (MSW) to a thermoplastic composite material as set forth in this clause or in combination with one or more of the preceding clauses, the system comprising:
a barrel having an inlet end and an outlet end;
a nozzle, mounted on the outlet end;
an inlet opening in the barrel proximate the inlet end, the inlet opening being sized to receive wet municipal solid waste mixture;
at least one screw auger rotatably mounted within the barrel, the at least one screw auger configured to cause a progressive pressure increase from the inlet end to the outlet end;
at least one motor connected to the at least one screw auger, for rotating the at least one screw auger in the barrel;
a fluid outlet located less than half a length of the barrel from the inlet end, the fluid outlet being configured to drain excess fluids from the wet municipal solid waste mixture in the barrel;
a fluid outlet located less than three quarters of the height of the barrel from the inlet end, the fluid outlet being configured to drain excess fluid from the wet municipal solid waste mixture in the barrel; and
a heater thermally coupled to the barrel, the heater being configured to heat the wet municipal solid waste mixture and the admitted fluid while the at least one screw auger causes an increase in pressure above atmospheric pressure to thereby superheat the fluid.

Clause 82. The system of any of clauses 1 to 81, further comprising a valve associated with the fluid outlet and a controller for regulating the valve to thereby maintain a desired fluid content in the barrel.

Clause 83. The system of any of clauses 1 to 82, further comprising a moisture sensor in the barrel, and wherein the controller is configured to monitor the fluid content via a connection to the moisture sensor.

Clause 84. The system of any of clauses 1 to 83, wherein the fluid outlet is positioned to drain backflow flowing from locations in the barrel downstream of the fluid outlet.

Clause 85. The system of any of clauses 1 to 84, wherein the fluid outlet is located less than a quarter a length of the barrel from the inlet end.

Clause 86. The system of any of clauses 1 to 85, wherein the fluid outlet is connected to a municipal sewer system.

Clause 87. The system of any of clauses 1 to 86, further comprising a controller, for regulating the at least one motor to maintain a pressure in the barrel sufficient to prevent boiling of the fluid.

Clause 88. The system of any of clauses 1 to 87, wherein the controller is configured to maintain a pressure in the barrel between about 1 MPa and about 50 MPa.

Clause 89. The system of any of clauses 1 to 88, wherein the nozzle is sized to cause fragments of the municipal solid waste mixture to experience cracking upon ejection from the nozzle.

Clause 90. The system of any of clauses 1 to 89, further comprising a fluid inlet in the barrel.

Clause 91. The system of any of clauses 1 to 90, wherein the fluid inlet is located no more than half a length of the barrel from the inlet end.

Clause 92. The system of any of clauses 1 to 91, wherein the fluid inlet is configured for connection to a municipal water supply.

Clause 93. The system of any of clauses 1 to 92, further comprising a valve associated with the fluid inlet, and a controller for monitoring fluid content in the chamber and regulating the valve in response thereto.

Clause 94. The system of any of clauses 1 to 93, further comprising a thermocouple in the barrel, and wherein the controller is further configured to control the heater based on feedback from the thermocouple.

Clause 95. The system of any of clauses 1 to 94, wherein the at least one screw auger includes two screw augers.

Clause 96. The system of any of clauses 1 to 95, wherein the at least one motor includes two motors, each motor for separately rotating a differing screw auger.

Clause 97. The system of any of clauses 1 to 96, wherein the inlet opening sized to receive a municipal solid waste mixture is sized to receive the municipal solid waste mixture in shredded form.

Clause 98. The method of any of clauses 1 to 97, wherein the liquid content includes water.

Clause 99. The method of any of clauses 1 to 98, wherein the liquid content has a boiling point of at least 100° C.

Clause 100. The method of any of clauses 1 to 99, wherein the first pressure level is between about 1 MPa and about 50 MPa.

Clause 101. The method of any of clauses 1 to 100, wherein the heating of the MSW is to a temperature that causes a substantial portion of the MSW to melt.

Clause 102. The method of any of clauses 1 to 101, wherein instantaneous reducing of the first pressure level causes shear forces acting on the heated MSW.

Clause 103. The method of any of clauses 1 to 102, wherein the shear forces shred the contents of the heated MSW.

Clause 104. The method of any of clauses 1 to 103, wherein the shear forces break intermolecular bonds in the heated MSW.

Clause 105. The method of any of clauses 1 to 104, wherein the heating followed by the instantaneous pressure reduction causes a volume of the composite material to be less than a volume of the raw MSW used to make the composite material.

Clause 106. The method of any of clauses 1 to 105, wherein the plastic content is at least about 6% by weight of the raw MSW.

Clause 107. The method of any of clauses 1 to 106, wherein the thermoplastic composite material is sterilized or neutralized relative to the raw MSW.

Clause 108. The method of any of clauses 1 to 107, wherein the forming is selected from a group consisting of extrusion, injection, molding, and casting.

Clause 109. The composite material of any one of clauses 1 to 108, wherein under an electron microscope, the composite material has a wool-like appearance.

Clause 110. The composite material of any one of clauses 1 to 109, wherein under an electron microscope, the composite material is characterized by a non-uniform polymeric mass with threads extending therefrom.

Clause 111. The method of any one of clauses 1 to 110, wherein the liquid content of the wet MSW is between about 6% and 80% by weight.

Clause 112. The method of any one of clauses 1 to 111, wherein the liquid content of the wet MSW is between about 20% and 40% by weight.

Clause 113. The method of any one of clauses 1 to 112, wherein the method further comprises adding water to the extruder during compressing.

Clause 114. The method of any one of clauses 1 to 113, wherein the heating is to a temperature that causes a substantial portion of the raw MSW to become molten.

Clause 115. The method of any one of clauses 1 to 114 wherein the method further comprises mixing and shearing the wet raw MSW in the extruder.

Clause 116. The method of any of one clauses 1 to 115 wherein the extruder includes a screw compressor.

Clause 117. The method of any one of clauses 1 to 116 wherein the pressure level is between about 1 MPa and about 50 MPa.

Clause 118. The method of any one of clauses 1 to 117 wherein the pressure level is between about 12 MPa and about 18 MPa.

Clause 119. The method of any one of clauses 1 to 118 wherein, during heating, a temperature of the wet raw municipal solid waste is raised to between about 150° C. and about 200° C.

Clause 120. The method of any one of clauses 1 to 119 wherein the nozzle includes an opening having a round cross-section.

Clause 121. A system for converting raw municipal solid waste (MSW) to a thermoplastic material as set forth in this clause or in combination with one or more of the preceding clauses, comprising:
a shredder configured to receive the raw MSW, to shred the raw MSW to a size less than or equal to a maximum size, and to expel the shredded MSW through a shredder outlet;
an extruder having an inlet opening configured for association with the shredder outlet to receive the shredded MSW, the extruder further including a barrel and at least one screw auger configured to rotate within the barrel to compress and further shred the shredded MSW, the extruder being adapted to facilitate conversion of the further shredded MSW into a thermoplastic material; and
an extrusion nozzle having an outlet opening, the outlet opening having a size greater than or equal to the maximum size.

Clause 122. The system of any one of clauses 1 -121 wherein the maximum size is 10 mm.

Clause 123. The system of any one of clauses 1-122 wherein the maximum size is less than 10 mm.

Clause 124. The system of any one of clauses 1-123 wherein the maximum size is less than 20 mm.

Clause 125. The system of any one of clauses 1-124 wherein the outlet opening of the nozzle is no more than 50% greater than the maximum size.

Clause 126. The system of any one of clauses 1-125 wherein the outlet opening of the nozzle is no more than 30% greater than the maximum size.

Clause 127. The system of any one of clauses 1-126 wherein the outlet opening of the nozzle is no more than 25% greater than the maximum size.

Clause 128. The system of any one of clauses 1-127 wherein the outlet opening of the nozzle is no more than 20% greater than the maximum size.

Clause 129. The system of any one of clauses 1-128 wherein the outlet opening of the nozzle is no more than 15% greater than the maximum size.

Clause 130. A method of processing wet municipal solid waste (MSW) as set forth in this clause or in combination with one or more of the preceding clauses, the method comprising:
superheating the wet municipal solid waste in an extruder;
conveying the superheated wet municipal solid waste toward a constricted nozzle end of the extruder; and
building pressure in the constricted nozzle end to cause the superheated wet municipal solid waste to exit the nozzle in a series of pulsed explosions, resulting in a stream of non-connected particles of a thermoplastic material.

Clause 131. The method of any one of clauses 1 to 130 wherein the method further includes pressurizing the superheated wet municipal solid waste in the extruder.

Clause 132. The method of any one of clauses 1 to 131 wherein the extruder is pressurized to between about 1 MPa and about 50 MPa.

Clause 133. The method of any one of clauses 1 to 132 wherein the extruder is pressurized to 15 MPa.

Clause 134. The method of any one of clauses 1 to 133 wherein the liquid in the superheated wet MSW has a boiling point of at least 100° C.

Clause 135. The method of any one of clauses 1 to 134 wherein superheating involves heating the wet MSW between about 100° C. and about 400° C.

Clause 136. The method of any one of clauses 1 to 135 wherein superheating involves heating the wet MSW to about 200° C. or greater.

Clause 137. The method of any one of clauses 1 to 136 wherein superheating the wet MSW causes a substantial portion of the wet MSW to melt.

Clause 138. The method of any one of clauses 1 to 137 wherein the series of pulsed explosions cause particle shredding.

Clause 139. The method of any one of clauses 1 to 138 wherein the series of pulsed explosions cause shear forces that break intermolecular bonds in the superheated wet MSW. Clause 140. The method of any one of clauses 1 to 139 wherein the series of pulsed explosions cause a volume of the thermoplastic material to be less than a volume of the wet MSW used to make the composite material.

Clause 141. The method of any one of clauses 1 to 140 wherein the wet MSW includes paper, organic material, plastic, metal, and glass.

Clause 142. The method of any one of clauses 1 to 141 wherein the series of pulsed explosions causes the thermoplastic material to be sterilized or neutralized relative to the wet MSW.

Disclosed embodiments may include any one of the following bullet-pointed features alone or in combination with one or more other bullet-pointed features, whether implemented as a system and/or method, by one or more hardware components disclosed herein, as well as by at least one processor or circuitry, and/or stored as executable instructions on non-transitory computer readable media or computer readable media.
a method of converting raw municipal solid waste (MSW) to a composite material with thermoplastic properties.
heating the MSW having a liquid content to a first pressure level, the first pressure level being sufficient to enable a temperature of the MSW to exceed an atmospheric boiling temperature of the liquid content.
instantaneously reducing the first pressure level of the heated MSW to a second pressure level.
enabling the liquid content to instantaneously boil.
instantaneously cause evaporation of substantially all the liquid content.
transforming the heated MSW into the composite material having thermoplastic properties.
the instantaneous boiling and the instantaneous evaporation are manifest in an explosion.
the method further includes causing a series of explosions in succession.
the liquid content is between about 6% by weight of the raw MSW and about 80% by weight of the raw MSW.
the liquid content is at least about 30% of the raw MSW by weight.
the liquid content is a combination of the liquid present in the raw MSW and a supplemental volume of liquid added during the heating or before the heating.
the liquid content is substantially absorbed by the heated MSW prior to the instant pressure reduction.
the second pressure level is atmospheric pressure.
during heating, the temperature of the MSW is raised to between about 100° C. and about 400° C.
the raw MSW includes a plastic content and a non-plastic content and wherein the non-plastic content includes at least one persistent material selected from metal, glass, thermoset polymer, and rock.
the instantaneous pressure reduction causes at least some of the persistent material be capsulized and embedded in the composite material.
properties of the composite material enable the composite material to be plastically formed into products.
a composite material having thermoplastic properties, and being formed from a municipal solid waste (MSW) stream including papers, plastics, metals, glass, and organics.
the composite material being made via a process comprising heating the MSW having a liquid content to a first pressure level, the first pressure level being sufficient to enable a temperature of the MSW to exceed an atmospheric boiling temperature of the liquid content, and instantaneously reducing the first pressure level of the heated MSW to a second pressure level to: enable the liquid content to instantaneously boil; instantaneously cause evaporation of substantially all the liquid content; and transform the heated MSW into the composite material having thermoplastic properties.
the composite material has a fibrous and flaky structure.
the composite material is porous.
a method of turning garbage into thermoplastic.
feeding wet raw municipal solid waste into an extruder.
compressing the wet raw municipal solid waste in the extruder to a pressure level above atmospheric pressure.
heating the wet raw municipal solid waste in the extruder.
advancing the wet raw municipal waste to a nozzle of the extruder for explosive cracking upon nozzle ejection.
a liquid content of the wet raw municipal solid waste is at least about 6% by weight.
injecting a liquid into the extruder.
during the heating, a temperature of the wet raw municipal solid waste is raised to between about 100° C. and about 400° C.
a region of the extruder immediately upstream of an opening of the nozzle constitutes a sudden decompression zone causing the explosive cracking.
an extruder nozzle adapted for causing municipal solid waste cracking.
an inlet end configured for connection to an extruder barrel.
an outlet end configured for expelling fragments of cracked municipal waste.
an auger-free compression zone proximate the inlet end, the auger-free compression zone having a first cross-sectional area.
a tapered zone, between the auger-free compression zone and the outlet end, the tapered zone progressively reducing in cross-sectional area from the compression zone to the outlet end, such that a second cross-sectional area at the outlet end is smaller than the first cross-sectional area to thereby enable a pressure increase in the tapered zone for facilitating micro-explosions in the municipal solid waste upon exit from the outlet end.
the nozzle is removable from the extruder barrel.
the inlet end of the nozzle is threaded for screw connection to the extruder barrel.
the extruder nozzle is metal.
the extruder nozzle is brass.
the extruder barrel has a bore opening and wherein a cross-sectional area of the compression zone corresponds to the bore opening.
the extruder barrel has a third cross-sectional area and a ratio of the second cross-sectional area at the outlet end of the nozzle is to the third-cross sectional area of the extruder barrel is about 1:1.25 to 1:12.
the ratio of the second cross-sectional area at the outlet end of the nozzle to the third-cross sectional area of the extruder barrel is about 1:3 to 1:8.
the extruder barrel has a throughput of municipal solid waste and wherein the second cross-sectional area at the outlet end enables micro-explosions in the municipal solid waste upon exit from the outlet end at the throughput.
the compression zone has a length larger than a length of the tapered zone.
a ledge in the tapered zone.
a size of the ledge is less than 90% of the tapered zone.
a size of the ledge is less than60% of the tapered zone.
a length of the nozzle is greater than 4 cm.
the length of the nozzle is greater than 10 cm.
the extruder nozzle is adapted for causing municipal solid waste cracking of municipal solid waste having a maximum size, and wherein the second cross-sectional area at the outlet end is larger than the maximum size.
the second cross-sectional area at the outlet is at least 10% greater than the maximum size.
the second cross-sectional area at the outlet is no more than 50% greater than the maximum size.
the extruder, connected to the nozzle.
the extruder further comprises at least one additional extruder nozzle adapted for causing municipal solid waste cracking having an inlet end configured for connection to the extruder barrel of the extruder.
a material (resin)
a plurality of thermally cracked fragments of thermoplastic material, each fragment having an irregular shape, an irregular size, an irregular surface area, flakes and whiskers extending therefrom, and wherein the plurality of thermally cracked fragments are heat-deformable for use in manufacture of thermoplastic goods.
the plurality of thermally cracked fragments include visible particulate matter non-uniformly embedded therein.
the visible particulate matter includes at least one material selected from metal, glass, ceramics or composites.
the visible particulate matter is of different size and shape.
the visible particulate matter is fully encapsulated in the resin, partly connected to the resin particles, or fully detached from the resin particles.
the visible particulate matter has kept its original size or shape or not.
the plurality of thermally cracked fragments are green, gray, black, or brown in color.
the gray color is variable from fragment to fragment.
the black color is variable from fragment to fragment.
the brown color is variable from fragment to fragment.
a combination of colors variable from fragment to fragment.
the plurality of thermally cracked fragments are of different shapes sizes.
the resin is of different sizes and shapes, from the shape and size of a puffed nuggets (15-100 mm of size), flakes (3-15 mm) or powder (<3 mm).
the plurality of thermally cracked fragments are a direct result of the methods and apparatuses disclosed herein, and depends directly on the pressure defined in the process, and not by cutting or grinding.
the plurality of thermally cracked fragments include flakes and whiskers.
the resin has whiskers—a matter in the form of fibers, fully or partially attached to the nucleus of the resin.
the whiskers are straight or curly, and different colors and sizes.
the whiskers are of different matter, or origin.
the whiskers are twirled with each other, in a dense or a loose formation.
the resin has flakes of matter, in different shapes, sizes and colors.
the flakes are of different matter and origin.
the flakes have a loose formation or coagulated manner.
a system for converting raw municipal solid waste (MSW) to a thermoplastic composite material.
a barrel having an inlet end and an outlet end.
a nozzle, mounted on the outlet end.
an inlet opening in the barrel proximate the inlet end, the inlet opening being sized to receive a municipal solid waste mixture.
at least one screw auger rotatably mounted within the barrel, the at least one screw auger configured to cause a progressive pressure increase from the inlet end to the outlet end.
at least one motor connected to the at least one screw auger, for rotating the at least one screw auger in the barrel.
a fluid inlet in the barrel, between the inlet end and the outlet end, the fluid inlet being configured to admit fluid into the municipal solid waste mixture in the barrel.
a heater thermally coupled to the barrel, the heater being configured to heat the municipal solid waste mixture and the admitted fluid while the at least one screw auger causes an increase in pressure above atmospheric pressure to thereby superheat the fluid.
the fluid inlet is a water inlet.
a controller, for regulating the at least one motor to maintain a pressure in the barrel sufficient to prevent boiling of the fluid.
the controller is configured to maintain a pressure in the barrel between about 1 MPa and about 50 MPa.
the nozzle is sized to cause fragments of the municipal solid waste mixture to experience cracking upon ejection from the nozzle.
the fluid inlet is located in a region of the barrel midway between the inlet and the outlet.
the fluid inlet is located no more than three quarters of a length of the barrel from the inlet end.
the fluid inlet is located no more than half a length of the barrel from the inlet end.
the fluid inlet is configured for connection to a water supply.
a valve associated with the fluid inlet, and a controller for monitoring fluid content in the chamber and regulating the valve in response thereto.
the controller is configured to regulate the valve to maintain a fluid content of between about 6% and 80% weight of the municipal solid waste mixture.
a moisture sensor in the barrel, and wherein the controller is configured to monitor the fluid content via a connection to the moisture sensor.
a thermocouple in the barrel, and wherein the controller is further configured to control the heater based on feedback from the thermocouple.
a fluid outlet in the barrel.
the fluid outlet is axially positioned at a location in the barrel between the inlet end and the fluid inlet.
the at least one screw auger includes two screw augers.
the at least one motor includes two motors, each motor for separately rotating a differing screw auger.
the inlet opening sized to receive a municipal solid waste mixture is sized to receive the municipal solid waste mixture in shredded form.
a system for converting wet municipal solid waste (MSW) to a thermoplastic composite material.
a barrel having an inlet end and an outlet end.
a nozzle, mounted on the outlet end.
an inlet opening in the barrel proximate the inlet end, the inlet opening being sized to receive wet municipal solid waste mixture.
at least one screw auger rotatably mounted within the barrel, the at least one screw auger configured to cause a progressive pressure increase from the inlet end to the outlet end.
at least one motor connected to the at least one screw auger, for rotating the at least one screw auger in the barrel.
a fluid outlet located less than half a length of the barrel from the inlet end, the fluid outlet being configured to drain excess fluids from the wet municipal solid waste mixture in the barrel.
a fluid outlet located less than three quarters of the height of the barrel from the inlet end, the fluid outlet being configured to drain excess fluid from the wet municipal solid waste mixture in the barrel.
a heater thermally coupled to the barrel, the heater being configured to heat the wet municipal solid waste mixture and the admitted fluid while the at least one screw auger causes an increase in pressure above atmospheric pressure to thereby superheat the fluid.
a valve associated with the fluid outlet and a controller for regulating the valve to thereby maintain a desired fluid content in the barrel.
a moisture sensor in the barrel, and wherein the controller is configured to monitor the fluid content via a connection to the moisture sensor.
the fluid outlet is positioned to drain backflow flowing from locations in the barrel downstream of the fluid outlet.
the fluid outlet is located less than a quarter a length of the barrel from the inlet end.
the fluid outlet is connected to a municipal sewer system.
a controller, for regulating the at least one motor to maintain a pressure in the barrel sufficient to prevent boiling of the fluid.
the controller is configured to maintain a pressure in the barrel between about 1 MPa and about 50 MPa.
the nozzle is sized to cause fragments of the municipal solid waste mixture to experience cracking upon ejection from the nozzle.
a fluid inlet in the barrel.
the fluid inlet is located no more than half a length of the barrel from the inlet end.
the fluid inlet is configured for connection to a municipal water supply.
a valve associated with the fluid inlet, and a controller for monitoring fluid content in the chamber and regulating the valve in response thereto.
a thermocouple in the barrel, and wherein the controller is further configured to control the heater based on feedback from the thermocouple.
the at least one screw auger includes two screw augers.
the at least one motor includes two motors, each motor for separately rotating a differing screw auger.
the inlet opening sized to receive a municipal solid waste mixture is sized to receive the municipal solid waste mixture in shredded form.
the liquid content includes water.
the liquid content has a boiling point of at least 100° C.
the first pressure level is between about 1 MPa and about 50 MPa.
the heating of the MSW is to a temperature that causes a substantial portion of the MSW to melt.
instantaneous reducing of the first pressure level causes shear forces acting on the heated MSW.
the shear forces shred the contents of the heated MSW.
the shear forces break intermolecular bonds in the heated MSW.
the heating followed by the instantaneous pressure reduction causes a volume of the composite material to be less than a volume of the raw MSW used to make the composite material.
the plastic content is at least about 6% by weight of the raw MSW.
the thermoplastic composite material is sterilized or neutralized relative to the raw MSW.
the forming is selected from a group consisting of extrusion, injection, molding, and casting.
under an electron microscope, the composite material has a wool-like appearance.
under an electron microscope, the composite material is characterized by a non-uniform polymeric mass with threads extending therefrom.
the liquid content of the wet MSW is between about 6% and 80% by weight.
the liquid content of the wet MSW is between about 20% and 40% by weight.
the method further comprises adding water to the extruder during compressing.
the heating is to a temperature that causes a substantial portion of the raw MSW to become molten.
the method further comprises mixing and shearing the wet raw MSW in the extruder.
the extruder includes a screw compressor.
the pressure level is between about 1 MPa and about 50 MPa.
the pressure level is between about 12 MPa and about 18 MPa.
during heating, a temperature of the wet raw municipal solid waste is raised to between about 150° C. and about 200° C..
the nozzle includes an opening having a round cross-section.
a system for converting raw municipal solid waste (MSW) to a thermoplastic material.
a shredder configured to receive the raw MSW, to shred the raw MSW to a size less than or equal to a maximum size, and to expel the shredded MSW through a shredder outlet.
an extruder having an inlet opening configured for association with the shredder outlet to receive the shredded MSW, the extruder further including a barrel and at least one screw auger configured to rotate within the barrel to compress and further shred the shredded MSW, the extruder being adapted to facilitate conversion of the further shredded MSW into a thermoplastic material.
an extrusion nozzle having an outlet opening, the outlet opening having a size greater than or equal to the maximum size.
the maximum size is 10 mm.
the maximum size is less than 10 mm.
the maximum size is less than 20 mm.
the outlet opening of the nozzle is no more than 50% greater than the maximum size.
the outlet opening of the nozzle is no more than 30% greater than the maximum size.
the outlet opening of the nozzle is no more than 25% greater than the maximum size.
the outlet opening of the nozzle is no more than 20% greater than the maximum size.
the outlet opening of the nozzle is no more than 15% greater than the maximum size.
a method of processing wet municipal solid waste (MSW).
superheating the wet municipal solid waste in an extruder.
conveying the superheated wet municipal solid waste toward a constricted nozzle end of the extruder.
building pressure in the constricted nozzle end to cause the superheated wet municipal solid waste to exit the nozzle in a series of pulsed explosions, resulting in a stream of non-connected particles of a thermoplastic material.
pressurizing the superheated wet municipal solid waste in the extruder.
the extruder is pressurized to between about 1 MPa and about 50 MPa.
the extruder is pressurized to 15 MPa.
the liquid in the superheated wet MSW has a boiling point of at least 100° C.
superheating involves heating the wet MSW between about 100° C. and about 400° C.
superheating involves heating the wet MSW to about 200° C. or greater.
superheating the wet MSW causes a substantial portion of the wet MSW to melt.
the series of pulsed explosions cause particle shredding.
the series of pulsed explosions cause shear forces that break intermolecular bonds in the superheated wet MSW.
the series of pulsed explosions cause a volume of the thermoplastic material to be less than a volume of the wet MSW used to make the composite material.
the wet MSW includes paper, organic material, plastic, metal, and glass.
the series of pulsed explosions causes the thermoplastic material to be sterilized or neutralized relative to the wet MSW.

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

Throughout the foregoing description, numerical sizes and ratios are provided by way of example only. It is to be understood that these dimensions and ratios are not in any way limiting of the broadest scope of this disclosure, where structures can be constructed in any workable sizes and with any workable ratios. In addition, although methods of this disclosure are presented for ease of discussion in connection with various structures, the methods, in their broadest sense, are not limited to particular structural details. This applies, for example, to the broad concept of cracking, where superheated liquid in waste is subject to a rapid pressure reduction. This process may be accomplished in numerous ways, and this disclosure is intended to cover those numerous ways.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Moreover, while illustrative embodiments have been described herein, the scope may include any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with a true scope and spirit being indicated by the following claims and their full scope of equivalents.

1. A method of converting raw municipal solid waste (MSW) to a composite material with thermoplastic properties, the method comprising:
heating the MSW having a liquid content to a first pressure level, the first pressure level being sufficient to enable a temperature of the MSW to exceed an atmospheric boiling temperature of the liquid content, and
instantaneously reducing the first pressure level of the heated MSW to a second pressure level to:
enable the liquid content to instantaneously boil;
instantaneously cause evaporation of substantially all the liquid content; and
transform the heated MSW into the composite material having thermoplastic properties.

2. The method of claim 1, wherein the instantaneous boiling and the instantaneous evaporation are manifest in an explosion.

3. The method of claim 2, wherein the method further includes causing a series of explosions in succession.

4. The method of claim 1, wherein the liquid content is between about 6% by weight of the raw MSW and about 80% by weight of the raw MSW.

5. The method of claim 1, wherein the liquid content is at least about 30% of the raw MSW by weight.

6. The method of claim 1, wherein the liquid content is a combination of the liquid present in the raw MSW and a supplemental volume of liquid added during the heating or before the heating.

7. The method of claim 1, wherein the liquid content is substantially absorbed by the heated MSW prior to the instant pressure reduction.

8. The method of claim 1, wherein the second pressure level is atmospheric pressure.

9. The method of claim 1, wherein during heating, the temperature of the MSW is raised to between about 100 C. and about 400° C..

10. The method of claim 1, wherein the raw MSW includes a plastic content and a non-plastic content and wherein the non-plastic content includes at least one persistent material selected from metal, glass, thermoset polymer, and rock.

11. The method of claim 10, wherein the instantaneous pressure reduction causes at least some of the persistent material be capsulized and embedded in the composite material.

12. The method of claim 1, wherein properties of the composite material enable the composite material to be plastically formed into products.

13. A composite material having thermoplastic properties, and being formed from a municipal solid waste (MSW) stream including papers, plastics, metals, glass, and organics, the composite material being made via a process, comprising:
heating the MSW having a liquid content to a first pressure level, the first pressure level being sufficient to enable a temperature of the MSW to exceed an atmospheric boiling temperature of the liquid content, and
instantaneously reducing the first pressure level of the heated MSW to a second pressure level to:
enable the liquid content to instantaneously boil;
instantaneously cause evaporation of substantially all the liquid content; and
transform the heated MSW into the composite material having thermoplastic properties.

14. The composite material having thermoplastic properties of claim 13, wherein the composite material has a fibrous and flaky structure.

15. The composite material having thermoplastic properties of claim 13, wherein the composite material is porous.

16. A method of turning garbage into thermoplastic, the method comprising:
feeding wet raw municipal solid waste into an extruder;
compressing the wet raw municipal solid waste in the extruder to a pressure level above atmospheric pressure;
heating the wet raw municipal solid waste in the extruder; and
advancing the wet raw municipal waste to a nozzle of the extruder for explosive cracking upon nozzle ejection.

17. The method of claim 16, wherein a liquid content of the wet raw municipal solid waste is at least about 6% by weight.

18. The method of claim 16, wherein the method further comprises injecting a liquid into the extruder.

19. The method of claim 16, wherein during the heating, a temperature of the wet raw municipal solid waste is raised to between about 100 C. and about 400 C..

20. The method of claim 16, wherein a region of the extruder immediately upstream of an opening of the nozzle constitutes a sudden decompression zone causing the explosive cracking.
